(19) United States
(12) Patent Application Publication
(10) Pub. No.: US 2018/0267282 A1
(43) Pub. Date: Sep. 20, 2018

(54) WIDE SPECTRUM OPTICAL SYSTEMS AND DEVICES IMPLEMENTING FIRST SURFACE MIRRORS

(71) Applicant: DIGITAL DIRECT IR, INC., Fresh Meadows, NY (US)

(72) Inventor: Peter N. Kaufman, Fresh Meadows, NY (US)

(21) Appl. No.: 15/716,489

(22) Filed: Sep. 26, 2017

Related U.S. Application Data
(63) Continuation of application No. 14/315,270, filed on Jun. 25, 2014, now abandoned.
(60) Provisional application No. 61/839,356, filed on Jun. 25, 2013.

(51) Int. Cl. G02B 17/08; G01J 3/02; G01N 21/25; G01J 5/50

(52) U.S. Cl. CPC G02B 17/08; G01J 3/0205; G01N 2021/3513; G01J 5/505; G01N 21/255

(57) ABSTRACT

Wide spectrum optical systems and devices are provided for use in multispectral imaging systems and applications, and in particular, wide spectrum optical assemblies are provided which are implemented using low cost, first surface mirrors in an optical framework that enables real-time viewing of an image in multiple spectral bands simultaneously over the same optical centerline with one main optical element.

### CROSS-REFERENCE TO RELATED APPLICATIONS

This application is a Continuation of U.S. patent application Ser. No. 14/315,270, filed on Jun. 25, 2014, which claims priority to U.S. Provisional Patent Application Ser. No. 61/839,356, filed on Jun. 25, 2013, the disclosures of which are fully incorporated herein by reference.

### TECHNICAL FIELD

The present invention generally relates to wide spectrum optical systems and devices for use in multispectral imaging systems and applications, and in particular, wide spectrum optical assemblies that are implemented using low cost, first surface mirrors in an optical framework that enables real-time viewing of an image in multiple spectral bands simultaneously over the same optical centerline with one main optical element.

### BACKGROUND

In general, conventional imaging systems known in the art implement optical lens assemblies and sensing/detection technologies for imaging target objects or scenes in radiation that falls in discrete spectral bands of the electromagnetic spectrum, such as the UV, visible, near IR, mid IR and far IR (infrared) spectrums, whereby such imaging systems are designed for optimal operation in one particular spectral band (e.g., visible light). However, for certain applications, imaging systems are designed for multi-spectral operation to image radiation in two or more discrete spectral sub-bands of the electromagnetic spectrum such as visible/near IR and mid/long wavelength IR bands. Indeed, in certain applications, the ability to image a target scene in the visible and IR spectral bands can allow viewing of target objects/scenes in normal level lighting conditions as well as low-level light conditions (e.g., dusk, smoke, bad weather conditions, long distance or objects that are close to background levels or weak emitters). There are various applications, such as military applications, where imaging targets of interest over a wide range of photonic wavelengths is important or otherwise desirable.

However, systems and devices for multispectral imaging applications (e.g., imaging in visible and infrared portions of the spectrum) are typically complex and costly, due to the different optics, image sensors and imaging electronics that are needed for each of the different spectral bands of interest. For multispectral applications, the use of refractive optics is especially problematic, where refractive optics are typically designed for specific spectral bands and cannot sufficiently provide wideband performance across a wide spectral range. Consequently, for multispectral applications, different optics must be used for each spectral band of interest (i.e., the same refractive optics cannot be commonly used over a wide range of spectral bands).

Presently, gemological or mineralogical optic materials are used for constructing refractive lenses for thermal imaging cameras (TiC), where such optics are very expensive because they are made of rare exotic high purity materials like silicon, sapphire and germanium to allow the camera to see the specific photonic energy spectrum of interest. These materials are very restrictive in that they are comparatively narrow bandwidth in nature and refractive optics made from such materials are only transparent at wavelengths relative to the material they are made from. These wavelengths seldom coincide exactly with those needed for the desired imaging bandwidth, so performance compromises must be made. For wideband operation, very expensive exotic fragile unstable lens materials have to be used and they also require performance compromises that make then difficult to implement and use. These materials have to be specially treated using complex processes and coatings to get them to perform as needed, which further contributes to the expense and complexity in manufacturing. Moreover, the wideband materials used to form refractive optics result in lenses that are very fragile, unstable and can be destroyed by small amounts of moisture or dirt.

IR energy wavelengths are not focusable thru common inexpensive materials such as glass or plastic which work for UV and visible light wavelengths. TiC's (thermal imaging cameras) and other imagers need to receive as much of the available photonic energy as possible to detect and create an image, especially at long distances and low emissive energy levels. The optical elements must pass as much of the available energy as possible on to the imager's detectors. Loss of photonic energy in the optics requires the imagers to be more sensitive which raises their cost. Reducing the costs for thermal imaging camera optics without sacrificing performance is necessary for TiCs to proliferate into main stream use. Having the ability to be truly wide spectrum as well as low cost adds the functionality of being usable at other wavelengths with the same lens.

Moreover, in applications where images from different spectral bands are combined or blended, the ability to spatially register the different images is problematic when the images are captured over different optical centerlines and separate imaging channels. Further, if quantitative scene measurements are desired, the use of different optics and detectors introduces measurement complexities and errors.

### SUMMARY

In general, exemplary embodiments of the invention include wide spectrum optical systems and devices that are implemented using first surface mirrors designed to provide low loss reflection over a wide spectrum of photonic radiation. Exemplary embodiments of the invention include methods for constructing first surface mirrors with reflective coatings made from very wide spectrum surface materials or narrow spectrum materials and coatings for enhancing optical performance and protecting the underlying reflective surface and optical coatings. For example, anti-reflection and/or protective layers can be formed by sprayed on or vacuum formed polymer materials such as polyethylene and polyurethane, cyanoacrylate materials such as DVC (deposited vaporized cyanoacrylate) or DLC (diamond like carbon) materials, which allows low cost fabrication of first surface mirrors with wide spectrum performance.

In other exemplary embodiments of the invention, one or more wide spectrum first surface mirrors (e.g. parabolic, spherical, aspherical and/or flat mirrors) are arranged in “off-axis” and/or “on-axis” configurations for implementing low cost front-end optical assemblies providing wide spectrum performance for various multi-spectral applications. In one exemplary embodiment, optical lens assembly can utilize a wide spectrum off-axis parabolic (OAP) mirror as a primary mirror to reflect and focus incident photonic energy from a scene to enable off-axis scene viewing over a wide range of spectral bands, as desired. In other embodiments, a primary off-axis parabolic mirror is formed with a small centerline through-hole that extends between the front reflective surface and back surface in the direction of, and aligned to, an optical centerline of the primary OAP mirror to allow simultaneous off-axis and on-axis scene viewing, both in wide band over the same optical centerline of the OAP mirror. Since on-axis and off-axis views are captured along the same optical centerline of the primary OAP mirror, a scene can be viewed in two or more spectral bands over the same optical centerline in real time without having parallax error.

In other exemplary embodiments of the invention, optical systems using a primary OAP mirror with or without a centerline through-hole provide a building block to implement various optical systems and devices providing wide spectrum operation for a wide range of applications. For instance, exemplary embodiments of the invention include interchangeable and adaptable optical lens assemblies in which a first surface OAP mirror is used as a primary optic for focusing, which allows the optical lens assemblies to be used as front-end optics for different imaging devices. In addition, exemplary optical lens assemblies can be designed with a primary OAP mirror with a centerline through hole to allow simultaneous off-axis and on-axis scene viewing by providing two individual and different wavelength images simultaneously from the same optical lens assembly over the same optical centerline of the primary optic.

In other exemplary embodiments of the invention, optical systems using a primary OAP mirror with or without a centerline through-hole are used for wide spectrum applications including centerline target designation and distance to target measurements, microscopy illumination, communications, non-contact temperature measurement, LADAR and radiation hardened uses.

These and other exemplary embodiments, aspects, features and advantages, of the present invention will become apparent from the following detailed description of exemplary embodiments, that is to be read in connection with the accompanying drawings.

### BRIEF DESCRIPTION OF THE DRAWINGS

FIG. 1 schematically illustrates conceptual frameworks of first surface mirrors according to exemplary embodiments of the invention.

FIGS. 2A, 2B, 2C and 2D schematically illustrate conceptual embodiments of using first surface OAP (off-axis parabolic) mirrors as primary mirrors in optical assemblies according to exemplary embodiments of the invention.

FIGS. 3A, 3B, 3C and 3D schematically illustrate optical lens assemblies according to exemplary embodiments of the invention, having self-contained wideband optics implementing a primary off-axis mirror.

FIGS. 4A and 4B schematically illustrate an imaging device and optical lens assembly disposed in a protective housing for environmentally controlled or outdoor applications.

FIG. 5 schematically illustrates an optical device according to exemplary embodiment of the invention having optical systems and imager systems integrated within a common housing.

FIGS. 6A, 6B, 6C and 6D1) schematically illustrate optical devices according to exemplary embodiments of the invention having optics with a primary off axis mirror and imaging electronics integrated within a common housing, and providing back focus and magnification functions.

FIGS. 7A, 7B, and 7C schematically illustrate optical device according to exemplary embodiments of the invention having optics with a primary off axis mirror and imaging electronics integrated within a common housing, in which multiple imagers are used enable simultaneous viewing of views of a target scene along the same optical centerline.

FIG. 8 schematically illustrates an optical device according to an exemplary embodiment of the invention in which heat sink components are used to provide active cooling of a primary OAP mirror.

FIGS. 9A, 9B, and 9C schematically illustrate optical systems according to exemplary embodiments of the invention for implementing CLTD (centerline targeting designator) functions.

FIGS. 10A, 10B and 10C schematically illustrate an optical device according to an exemplary embodiment of the invention for CLTD (centerline targeting designator) applications and distance to target precision measurement applications using two external fixed lasers.

FIG. 11 schematically illustrates an optical device according to another exemplary embodiment of the invention, which is designed for targeting designator and distance to target precision measurement applications using multiple lasers of different wavelengths along a common optical centerline of a primary OAP mirror combined by a beam splitter.

FIG. 12 schematically illustrates an optical device according to another exemplary embodiment of the invention which is designed for targeting designator and distance to target precision measurement applications using a laser beam source disposed behind a secondary mirror having a through hole.

FIGS. 13A and 13B schematically illustrate optical systems according to exemplary embodiments of the invention for implementing LADAR applications.

FIGS. 14A and 14B schematically illustrate optical systems according to exemplary embodiments of the invention using Boroscopes.

FIGS. 15A and 15B schematically illustrate optical devices according to exemplary embodiments of the invention for implementing Photonic Bi-Directional Laser Communications (BDLC) applications.

FIGS. 16A-16E schematically illustrate optical devices according to exemplary embodiments of the invention for implementing remote reading IR thermometer systems.

FIG. 17 schematically illustrates an optical system according to an exemplary embodiment of the invention to provide a wide view using an external dome mirror.

FIG. 18 schematically illustrates an optical system according to an exemplary embodiment of the invention to provide a wide view using a conventional primary fish-eye lens.

FIG. 19 schematically illustrates an optical system according to an exemplary embodiment of the invention to provide a wide view using an external corner mirror.

FIGS. 20A and 20B schematically illustrate an optical system according to an exemplary embodiment of the invention to provide a wide view using an external corner mirror having cameras or lasers behind each flat surface of the corner mirror

FIG. 21 schematically illustrates a microscope formed using first surface off axis mirror optics according to an exemplary embodiment of the invention.

FIGS. 22A, 22B and 22C illustrate optical devices according to exemplary embodiment of the invention in which the optics are implemented using a planar first surface mirror as the primary mirror.

FIG. 23 schematically illustrates and optical system for viewing a readout image of an IR imager according to an exemplary embodiment of the invention.

FIG. 24 schematically illustrates an optical device having a cassegrian-type optical framework according to an exemplary embodiment of the invention.

FIG. 25 schematically illustrates an optical device having a cassegrian-type optical framework according to another exemplary embodiment of the invention.

FIG. 26 schematically illustrates and optical device having a cassegrian-type optical framework according to another exemplary embodiment of the invention.

### DETAILED DESCRIPTION OF EXEMPLARY EMBODIMENTS

Exemplary embodiments of wide spectrum optical systems, devices and assemblies for use in multispectral imaging systems and applications, which are implemented using low cost, wide spectrum first surface mirrors will now be discussed in further detail. For ease of reference, the following detailed description of exemplary embodiments is divided into various sections for ease of reference.

### Wide Spectrum First Surface Mirrors

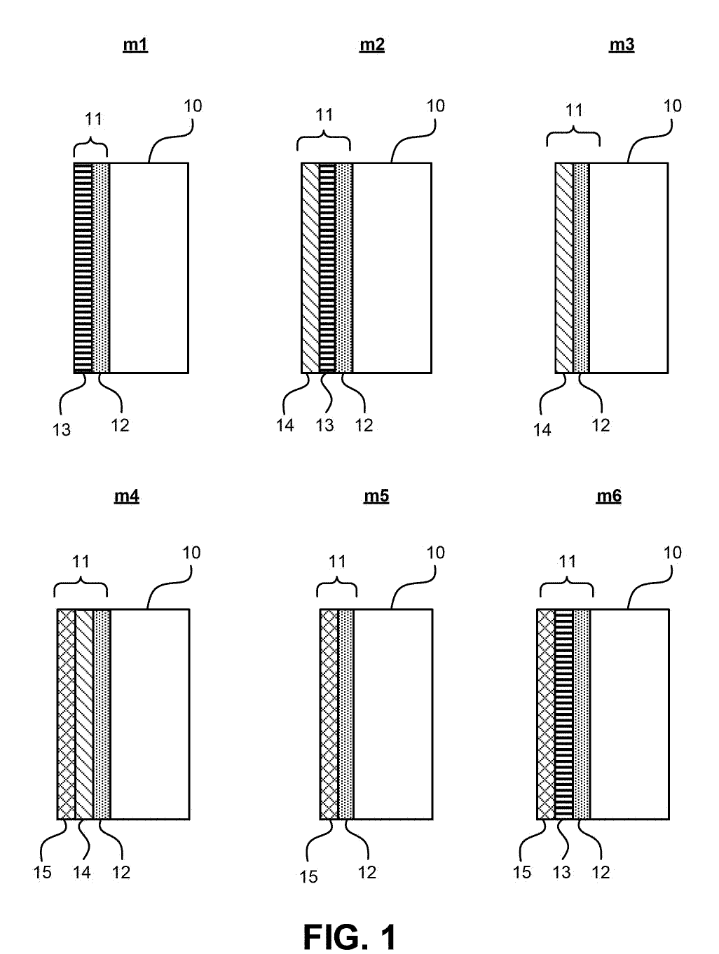

FIG. 1 schematically illustrates conceptual frameworks of first surface mirrors according to exemplary embodiments of the invention. In general, FIG. 1 schematically illustrates a plurality of first surface mirrors (m1˜m6) each comprising a mirror substrate (10) (or “mirror body”) and a front reflective surface (11) comprising one or more spectral coatings formed on a front-side surface of the substrate (10). In FIG. 1, the first surface mirrors (m1˜m6) are shown to have front reflective surfaces (11) formed of different stacked layer combinations of spectral coatings which generally include, for example, a reflective spectral layer (12), an anti-reflective (AR) layer (13), a protective layer (14), and a combination protective/AR layer (15). The types of materials used to form the mirror substrate (10) and reflective surface coating (11) can vary depending on the application and the desired spectral band(s) of operation, to provide loss, wide spectrum reflection of incident photonic radiation over the full photonic spectrum or wide range of spectral sub-bands of interest, as desired.

In general, the mirror substrate (10) can be formed using various materials such as glass, metal, plastic, ceramic or other suitable materials depending on the application. For ease of illustration, the mirrors (m1˜m6) are depicted in FIG. 1 as being planar first surface mirrors having a planar mirror substrate (10). It is to be understood, however, that the mirror substrates (10) can be formed with curved front surfaces for parabolic, spherical, or aspherical mirrors, etc. Depending on the desired shape of the mirror (planar or curved) and the material used to form the mirror substrate (10), the mirror substrate (10) may be CNC machined, molded, stamped or lathe cut and may be polished abrasively, chemically, photonically or with a conformal coating or CNC diamond cutting, using known techniques.

In FIG. 1, the various layers of first surface materials (12-15) forming the front reflective surfaces (11) of the mirrors (m1˜m6) can be formed of various types of materials and layer configurations that provide first surface mirrors capable of reflecting photonic radiation with low loss over a wide spectrum for the given application. In FIG. 1, each mirror (m1˜m6) is depicted with a front reflective surface (11) having a reflective layer (12) formed on a front-side surface of the mirror substrate (10). The reflective layer (12) is a reflective spectral coating (RSC) to reflect incident photonic radiation for a desired spectral bandwidth. The reflective layer (12) may be formed of deposited metals and alloys for reflectance, such as aluminum, gold, copper, silver, beryllium, platinum etc., or other suitable materials or combination of materials that can reflect photonic radiation over a wide spectrum. It is to be understood that other sub coating layers may be formed on the surface of the substrate (10) prior to formation of the reflective layer (12) so as to facilitate adhesion of the reflective coating to the substrate or to improve surface smoothness. The reflective layer (12) is optional when the mirror substrate (10) is made of an appropriate reflective material like aluminum, gold, copper, silver, platinum etc. for the desired reflection bandwidth.

In some embodiments, the AR layer (13) may be formed over the reflective layer (12) as in the exemplary mirrors m1, m2 and m6 shown in FIG. 1. The AR layer (13) may be formed as a performance enhancing layer that serves to increase the percent of photon reflection in one or more spectral bands and/or provide spectral band filtering. The AR layer (13) and can be made of materials that serve as a protective coating to protect the underlying reflective layer (12). The AR layer (13) can be formed of ZnSe, ZnS, Ge, SiO2, Si or other suitable materials that are known in the art. The AR layer (13) can provide spectral band filtering or a physical protection coating called a hardness coating (HIC). For example, SiO2 is a material that may be used as both a protective coating (as it is harder than the reflective material) as well as AR enhancement depending on the deposition method used.

In some embodiments, the protective layer (14) may be formed on the AR layer (13) (mirror m2) or directly on the reflective layer (12) (mirror m3). The protective layer (14) may be made of polyethylene, such as HDPE, LDPE or a DVC (deposited vaporized cyanoacrylate) deposited in a thin layer. If the protective layer (14) is formed of polyethylene that provides a matte finish, the protective layer (14) also serves as an antireflection layer. The protective layer (14) may also be made from Diamonex DLC (diamond like carbon), an amorphous carbon material. This can be deposited using Low Temperature (150° C.) CVD Plasma and Ion Beam Thin Film Deposition.

In other embodiments, the protective/AR layer (15) may be formed on the protective layer (14) (mirror m4), the reflective layer (12) (mirror m5) or on the AR layer (13) (mirror m6) to provide both protection of the underlying layers as well as antireflection. The protective/AR layer (15) may be a sprayed on polyurethane layer to protect underlying layers. If the sprayed on polyurethane layer has a matte finish, the polyurethane layer can serve as an AR coating. The layer (15) can also be a DVC layer. Moreover, a polyurethane material may be used as an AR and protective coating on top of the reflective layer (2). A deposited vaporized cyanoacrylate (DVC) material on top of the reflective layer (2) may be used as an AR and protective coating.

It is to be understood that first surface mirrors of FIG. 1 can be fabricated using materials and state of the art techniques that are known in the art. It is believed, however, that antireflective and/or protective coatings (such as layers 13, 14 and 15) as discussed above, which are formed with materials such as (1) sprayed on or vacuum formed polymer materials such as polyethylene and polyurethane, (2) cyanoacrylate materials such as DVC (deposited vaporized cyanoacrylate) or (3) DLC (diamond like carbon) materials are novel materials and methods that have been discovered by the inventors to be suitable for constructing low cost first surface mirrors with wide spectrum performance. Indeed, the use of polyethylene, polyurethane and cyanoacrylic materials are advantageous in that such materials are very low cost, readily accessible, easily applied, use very simple manufacturing and application techniques and can be processed at or near room temperature. They do not require a clean room or highly specialized environment or machinery.

Moreover, first surface mirrors with spectrum enhanced coatings and reflective surfaces as discussed above can be used to implement low cost optics that yield wide spectrum performance for various multi-spectral applications, as compared to conventional visible light materials (i.e.: glass or plastic), or IR mineralogical or gemological materials, first surface mirrors can be designed to provide wideband performance anywhere from UV (1-400 nm), Visible Light (400 to 750 nm), Near IR (750 nm to 2 microns), Lo band IR (2 to 5 microns), Mid band IR (5 to 30 microns) to Far IR (30 to 100 microns).

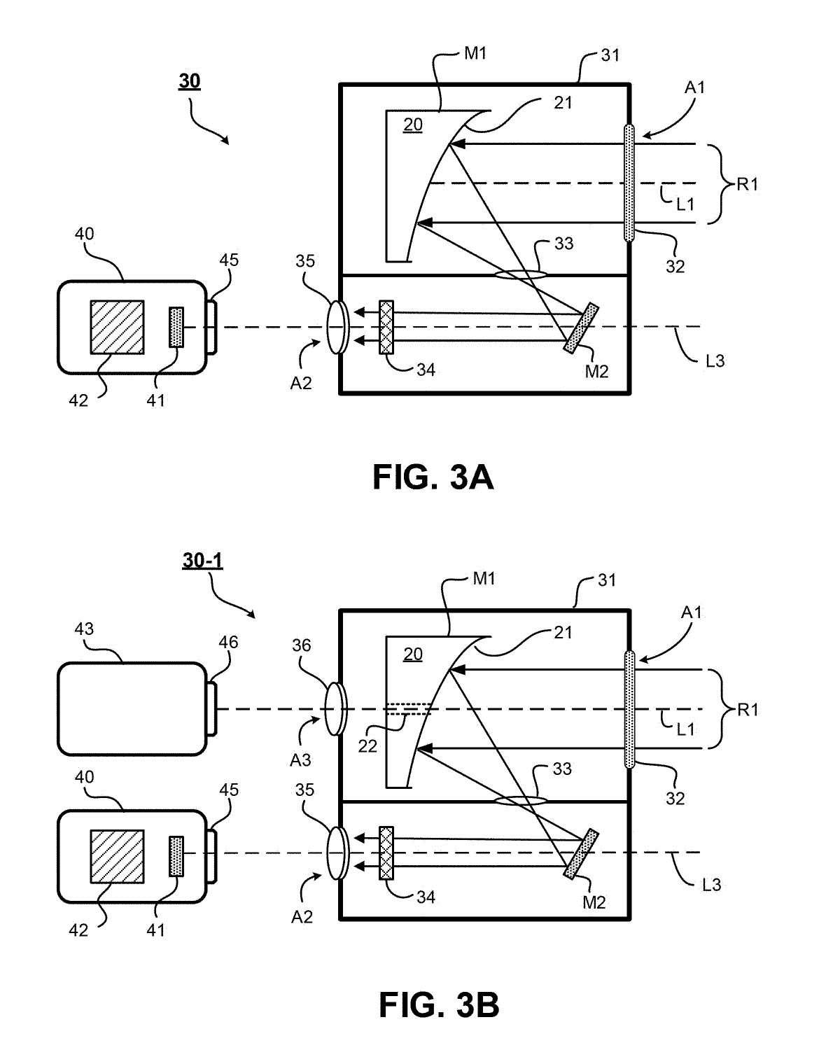

In other embodiment, protective windows, which can be applied to input apertures of lens assemblies or other optical devices, can be formed using protective coating materials similar to those discussed above that are formed on the mirror surface. For example, a protective window can be applied at the lens input aperture to protect the inner optical components without decreasing the overall performance of the system (e.g., protective window (32) as depicted in FIG. 3A, for example). In one embodiment, a protective window can be formed of a Polyethylene sheet which provides a protection as well as antireflection if the sheet material has a matte surface It can be made with matte surface inside and out without changing the transmission ratio significantly. A Polyethylene sheet can be used for outdoor window protection material in the 8 to 14 μm range. A matte finish on the front and back of the polyethylene can be applied to serve as an AR surface.

In another embodiment, a protective window can be formed with multiple layers. For example, a protective window can be formed to with a polyethylene sheet and a matte finish polyurethane layer as an AR coating for the polyethylene sheet. The use of polyurethane as an AR coating on the protective window in the manner and configuration described is a novel design, which requires very low cost material that is readily available, easily applied, usable at room temperatures and does not require a special clean room environment.

In other embodiments, the materials and layers applied to the mirrors, windows and protective covers can be cryogenically treated to harden and stabilize the materials and their attachment to the adjacent layers. It will also improve their optical performance and make them more dimensionally and molecularly stable over a wider temperature range.

Wide Spectrum Optical Frameworks Implementing Primary Off-Axis Mirror

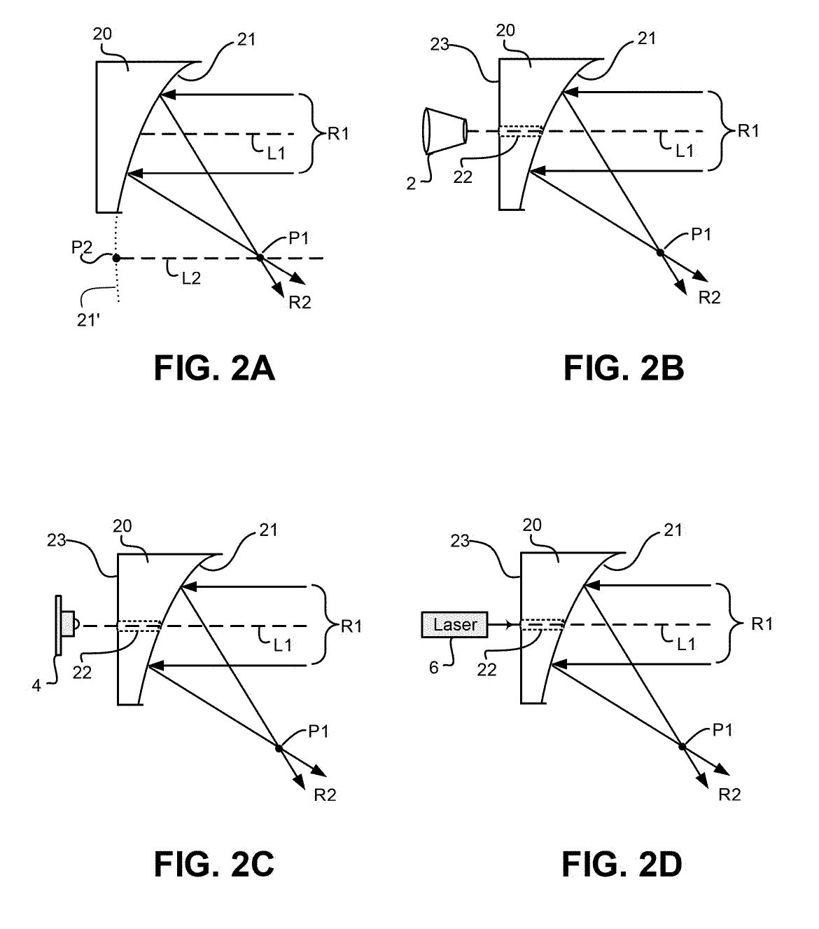

It is to be appreciated that various optical systems and devices according to exemplary embodiments of the invention may be designed for wide spectrum operation using front-end optical frameworks in which a first surface, OAP (off-axis parabolic) mirror is used as a primary mirror to reflect and focus incident photonic energy from a scene. FIGS. 2A, 2B, 2C and 2D schematically illustrate conceptual embodiments of using first surface OAP (off-axis parabolic) mirrors as primary mirrors in optical assemblies according to exemplary embodiments of the invention.

FIG. 2A schematically illustrates the use of a first surface OAP mirror (20) as a primary mirror for wide spectrum optical applications. The OAP mirror (20) comprises a front parabolic reflective surface (21) that reflects a column of incoming parallel rays (R1) of incident photonic radiation and focuses the reflected radiation to form a cone of reflected rays (R2) that converge at a focal point (P1). As is known in the art, the OAP mirror (20) may be viewed as a segment of a parent parabola wherein the reflective surface (21) of the mirror (20) is a portion of the parent parabola surface (21′) (shown as a dotted line. The OAP mirror (20) has an optical centerline (L1) that is parallel to an optical axis (12) of the parent parabola. The optical centerline (1.1) is an imaginary line that extends from the optical center (or mechanical center) of the OAP mirror (20). The optical axis (L2) (or parabolic axis of symmetry) is an imaginary line that extends from a vertex point (P2) on the surface (21′) of the parent parabola to the focal point (P1).

The OAP mirror (20) can be formed using materials and methods discussed above with reference to FIG. 1 to provide low loss reflection of photonic radiation over a wide spectrum as desired for a given applications. For example, the primary OAP first surface mirror (20) may be formed of a non-metallic substrate material and having a front reflective surface (21) formed with one or more reflective, AR and/or protective coatings as discussed with reference to FIG. 1.

The wide spectrum primary OAP mirror (20) can be used as a primary mirror in a wide range of optical systems and applications providing wide spectrum operation for multispectral imaging applications. The primary OAP mirror (20) focuses the incident photonic radiation “off axis” to the focal point (P1) leaving the area in front of the primary OAP mirror unobstructed. Depending on the application, the photonic energy reflected and focused by the primary OAP mirror (20) can be directed to an imager or a real-time eye viewer, for example, or a secondary first surface mirror (which can be a flat, spherical or parabolic first surface mirror) that redirects the intermediate off axis image formed by the focused rays (R2) to an imager or viewer. The imager can pass the image data to camera electronics that create a viewable video signal as in a conventional video system. The imager can be integrated into the housing (10) or part of another device. The optical system of FIG. 2A can be an interchangeable lens assembly configured to attach to an imaging device (e.g., IR camera body) via conventional industry standard mounts (i.e.: bayonet, C-mount, CS-mount, etc.), and serve as a common optical lens unit that may be utilized for different applications, as will be discussed below.

FIGS. 2B, 2C and 2D depict exemplary embodiments in which the primary OAP mirror (20) in FIG. 2A is formed with a small through-hole (22) that extends between the front reflective surface (21) and a back surface (23) of the mirror (20) in the direction of, and aligned to, the optical centerline (L1). The primary OAP mirror (20) with the through-hole (22) can be used as a basic building block to implement optical systems and lens assemblies in which the same optic allows simultaneous off-axis and on-axis scene viewing, both in wide band over the same optical centerline, as well as other applications as will be discussed below

In particular, FIG. 2B illustrates an exemplary embodiment of the primary OAP mirror (20) having a through-hole (22) to enable direct viewing of the scene by looking through the center hole (22) with or without a pin-hole lens (2). With this configuration, the primary OAP mirror (20) generates an off-axis image (R2) of a scene while allowing the user to view the scene in real time by eye via the pin hole lens (2) over the same optical centerline (L1). Similarly, FIG. 2C illustrates an exemplary embodiment of the primary OAP mirror (20) having a through-hole (23) to allow direct viewing of the scene in real-time using a single board pin hole camera (4) while simultaneously viewing the scene in real time using the off-axis image (R2).

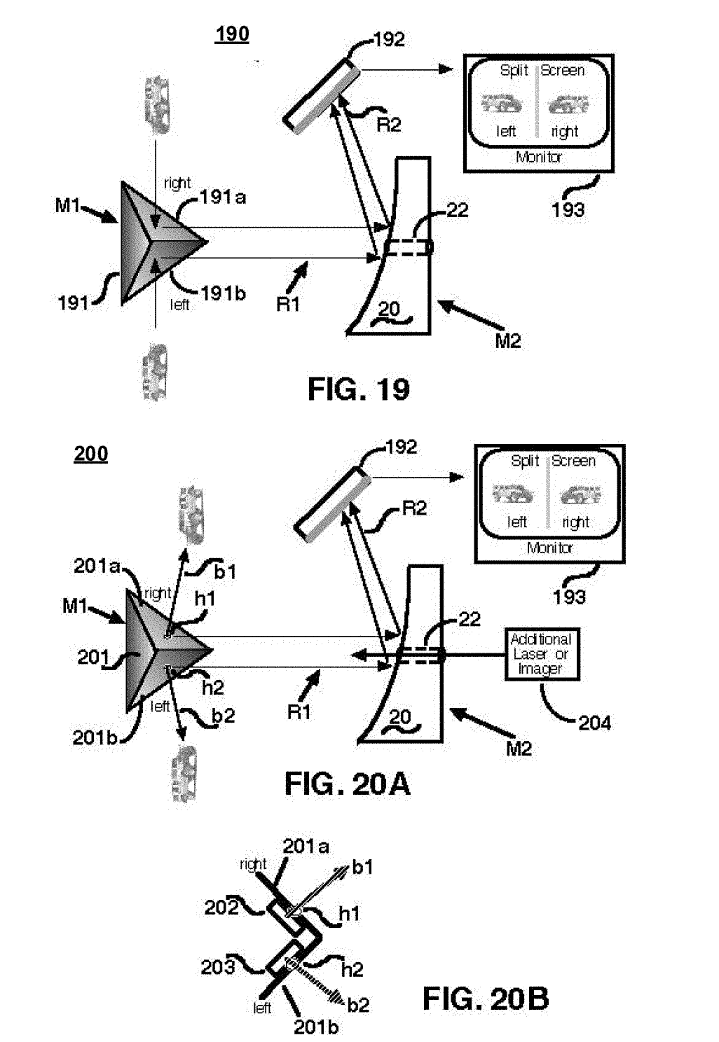

FIG. 2D illustrates an exemplary embodiment of the primary OAP mirror (20) having a through-hole (22) and a laser device (6) to send out a laser beam over the same optical centerline (L1) without interfering with the viewed scene. The laser beam emitted from the laser (6) will pass through the centerline hole (22) and a create a “laser spot” on a viewed object on the centerline of the primary mirror's image, wherein the laser spot can be viewed in real time in the systems image. The use of a laser (6) with a primary OAP mirror (20) having a centerline through-hole (22) as in FIG. 21), can be implemented in various exemplary applications, such as CLTD (Centerline Targeting Designator) applications to accommodate visual access like a gun sight, for example, and real time laser targeting as well as direct and indirect (from the video signal and pixel spacing) measuring of target distance, as will be discussed in detail below.

The through hole (22) can be cut in the main mirror substrate directly in the center from front to back, and having a diameter sufficiently small (e.g., 1 to 5 mm in diameter) so as to not have a significant effect on the overall off-axis image but large enough to allow passage of photonic energy from a scene propagating along the optical centerline through the substrate of the primary OAP mirror (20) to a small pin-hole lens (FIG. 2B) or video camera (4) (FIG. 2C) in the back of the mirror (20), or send a laser beam traveling out over the centerline of the incoming image (FIG. 2D). In other exemplary embodiments discussed below, other small holes can be located parallel to the central hole anywhere on the mirror body to perform other functions as will be discussed below.

The use of a “centerline” through-hole (22) in the exemplary embodiments of FIGS. 2B, 2C and 2D is to be contrasted with telescope (Newtonian) systems in which a concave primary mirror has a center hole and a small mirror is located centrally out in front of the primary mirror aligned to the hole to redirect the focused “on-axis” image through the hole in the primary mirror. In such a conventional design, the center hole in the primary mirror must be large enough to pass the entire image reflected by the secondary mirror, e.g., as large as 10-20% or more of the mirror's active area. This large hole reduces the performance and makes it unusable for anything but long distance viewing as the large through hole would be visible in close up imaging applications. In contrast, the off-axis mirror (20) with the small through hole (22) generates an “off-axis” image and allows close up imaging without the center through-hole being visible in the field of view of the “off-axis” image.

### Self-Contained Optical Lens Assemblies

In some exemplary embodiments of the inventions, first surface OAP mirrors are used for building low cost and low loss front-end optics for wide spectrum applications. FIGS. 3A, 3B, 3C and 3D illustrate basic conceptual embodiments of optical lens assemblies according to exemplary embodiments of the invention, in which a wide spectrum, off-axis parabolic mirror is used as a primary mirror to focus and reflect incident photonic energy from a scene. In general, FIGS. 3A and 3B and 3C schematically illustrate exemplary embodiments of interchangeable optical lens assemblies having a self-contained wide spectrum optical system within a lens housing and implementing standard industry camera lens mounting or adapter mechanisms with or without focus and F-stop variability capability, so as to be removably attaché to various camera bodies including movie cameras, CCTV cameras, security surveillance cameras, industrial cameras, microscope phototubes, consumer and professional still cameras, etc. FIG. 3D schematically illustrates an exemplary embodiment of an optical lens assembly that serves as a “secondary lens” designed to fit over a conventional “primary lens” of a camera body without the need to remove the primary lens from the camera body and provide additional functionalities not supported by the primary lens.

More specifically, FIG. 3A schematically illustrates an optical lens device (30) according to an exemplary embodiment of the invention, which comprises a device housing (31) having an input aperture (A1) (or entrance aperture) and an output aperture (A2). The lens assembly (30) comprises an optical system that includes a primary mirror M and secondary mirror M2. The primary mirror M1 is an OAP mirror (20) (such as discussed with reference to FIG. 2A) having wideband reflective surface (21), which is fixedly positioned within the lens housing (31) such that the wideband front reflective surface (21) faces the input aperture (A1) of the lens housing (31) and such that an optical centerline (L1) of the OAP mirror (20) extends from the wideband reflective surface (21) through the input aperture (A1). The input aperture (A1) may have a protective window (32) to protect the internal components from environmental contamination and provide wide spectrum transmission of photonic radiation and/or spectral filtering window (32) as discussed above.

The primary mirror M1 reflects incident radiation from a scene directed at the wide spectrum reflective surface (21) from the input aperture (A1) along the optical centerline (L1) to form an intermediate off axis image formed by the focused rays (R2) The photonic energy reflected and focused by the primary OAP mirror (20) passes through an opening (33) in a field stop to the secondary mirror M2. The opening (33) serves to prevent stray light rays from passing to the secondary mirror M2. The opening (33) may include a spectral filter window which can be narrow or wide bandwidth. The secondary mirror (M2) reflects the focused off-axis image rays (R2) through an optional iris or aperture (34) along an optical path aligned to an optical output centerline (L3) of the output aperture (A2). The secondary mirror (M2) may be a planar first surface mirror as shown in FIG. 3A, although in other exemplary embodiments discussed below, the secondary mirror (M2) may be a concave or spherical mirror (for focusing) or a combination of other mirrors may be used for focusing and redirecting the “off-axis” image to the output (A2) as necessary.

The optical lens assembly (30) can be an interchangeable lens assembly configured to attach to an imaging device (40) (e.g., IR camera body) via conventional industry standard mounts (i.e.: bayonet, C-mount, CS-mount, etc.), and serve as a common optical lens unit that may be utilized for different applications, as will be discussed below. The optical lens (30) comprises a mounting mechanism (35) that couples to a corresponding lens mounting mechanism (45) at the input of the imaging device (30) such that output aperture (A2) of the device housing (31) is aligned to an input of the imaging device (40). The imaging device (40) is illustrated as having an imager (41) and imaging electronics (42), which are used for imaging the “off-axis” image captured and output from the front end optical lens (30).

It is to be appreciated that the optical lens assembly (30) of FIG. 3A can be implemented as an interchangeable optical lens device that can be implemented for imaging a wide spectrum of photonic radiation and attached to suitable imaging devices or camera for a particular application. For example, the primary and secondary mirrors M1 and M2 can be designed to provide low loss reflection over a wide spectrum of photonic radiation so as to efficiently generate and output off-axis image of a target scene for processing by the imaging device (40). The optical lens (30) can have a selectable filtering mechanism to generate an “off axis” image having photonic radiation for a desired band(s) and prevent damage to an imaging chip (41) of the particular imaging device (40). For example, the field stop opening (33) may be implemented having a rotating multi-filter wheel with multiple different filters that can be selectively switched on the fly to filter or enhance specific spectral characteristics or to accommodate the different spectral requirements in a multi-imager configuration. The different filters can be selected by aligning one of the filters in correct position in the optical path between the primary and secondary mirrors M1 and M2. The wheel can be moved manually or by remote control with a motor, stepper motor or solenoid, in this regard, the photonic radiation of the “off axis” image that is reflected and directed to the output (A2) can be spectrally filtered to the target application.

FIG. 31 schematically illustrates an optical lens device (30_1) according to an exemplary embodiment of the invention. The exemplary optical lens device (30_1) of FIG. 3B is similar to the optical lens device (30) of FIG. 3A, but the primary OAP mirror (M1) includes a centerline through-hole (22) that allows “on-axis” viewing of a target scene using a second imaging device (43) that can be attached to the optical lens (30_1). The optical lens assembly (30) comprises a mounting mechanism (36) disposed at a second aperture (A3) of the lens housing (31), which couples to a corresponding mounting mechanism (46) at the input of the imaging device (43). The through hole (22) of the primary OAP mirror (20) allows incident radiation propagating along the optical centerline (L1) to pass through the hole (22) and be output from the second output aperture (A2) to the input of the second device body (44) m wherein the optical input axis of the second imaging device (43) is aligned to the centerlines (L1) of the primary mirror (M1), thereby providing a first view (on-axis view) of the target scene along the optical centerline (L1).

The exemplary framework of FIG. 3B enables simultaneous “on-axis” and “off-axis” viewing of a target scene for different spectral bands of photonic radiation. For example, the first imaging device (40) may be a thermal imaging camera used to image the scene in an IR spectral band with the imaging device (40) connected to the first output aperture (A2), while the second imaging device (43) may be a video camera used to image the scene in the visible spectral band with the second imaging device (43) connected to the second output (A3). Since the individual on-axis and off-axis views are captured along the same optical centerline (L1), the optics system allows viewing of two or more spectral bands over the same optical centerline in real time without having parallax error.

FIG. 3C schematically illustrates an optical lens device (30_2) according to another exemplary embodiment of the invention. The exemplary optical lens device (30_2) of FIG. 3C is similar to the optical lens device (30) of FIG. 3A, but the primary OAP mirror (M1) includes a centerline through-hole (22) that allows “on-axis” viewing of a target scene using a second imaging device (48) that is disposed within the optical lens housing (31). The second imaging device (48) may be an internal camera disposed in the housing of the lens assembly (30_2) to provide a video (visible) “on-axis” image simultaneously with an “off-axis” image via device (41), as discussed with reference to FIG. 3B.

It is to be appreciated that the interchangeable lens assemblies of FIGS. 3A, 3B and 3C can be manufactured with Iris (F-stops) variability and focus ability (manual, remote or automated), and mounting systems such as ANSI Std# B1.1 Mount types: C, CS—Still Cameras (Canon, Nikon, Olympus etc.) PD, IF, bayonet, OM, K-mount, M42, T-mount, K-mount, and others to provide a self-contained optical system used in a lens casement utilizing standard industry camera mount configurations with or without focus and F-stop variability capability.

FIG. 3D schematically illustrates an exemplary embodiment of an optical lens assembly that serves as a “secondary lens” designed to fit over a conventional “primary lens” of a camera body without the need to remove the primary lens from the camera body and provide additional functionalities not supported by the primary lens. In particular, FIG. 3D schematically illustrates an optical lens device (30_3) that is similar to the optical lens device (30) of FIG. 3A, but the optical lens housing (31) comprises an adapter mechanism (37) at the output aperture (A2) that is designed to removably couple to an existing lens (primary lens) (47) of an imaging device (44) without the need to remove the lens (47) from the camera (44), whether the primary lens (47) is fixed or removable. The optical lens assembly (30_3) includes an added region (31A) within the housing (31) that may include appropriate packaging to mount the optical lens (30_3) over the front of the existing lens (47) (fixed or removable) of the camera (44), as well as include an optical framework that is designed to provide optical functionality not within the ability of the existing lens such as, e.g., different focal length, focus or zoom etc. This embodiment permits in-field optical changes without having to remove the camera lens and expose the internal camera parts to the elements. If a camera has a lens that is not removable, it permits changing the cameras characteristics at any time, quickly and easily. An optical lens assembly such as in FIG. 3D can be readily designed to be adapted to existing camera lenses to augment the cameras performance for increased performance and lower cost.

In accordance with exemplary embodiments of the invention, the optical lens assemblies of FIGS. 3A, 3B, 3C and 3D, for example, can be readily designed using known components and methods to be compatible with standard and non-standard camera systems and functions—providing similar magnification and field of view (FOV) to what is available from conventional lens configurations. A plurality of optical lens assemblies according to the invention can be designed as “Off the Shelf” models that coincide with common industry parameters and functions with regard to focus configurations: fixed focus, variable focus, zoom, macro and micro focus with multiple spherical elements, and regular lens equivalent with fixed FOV and variable focus.

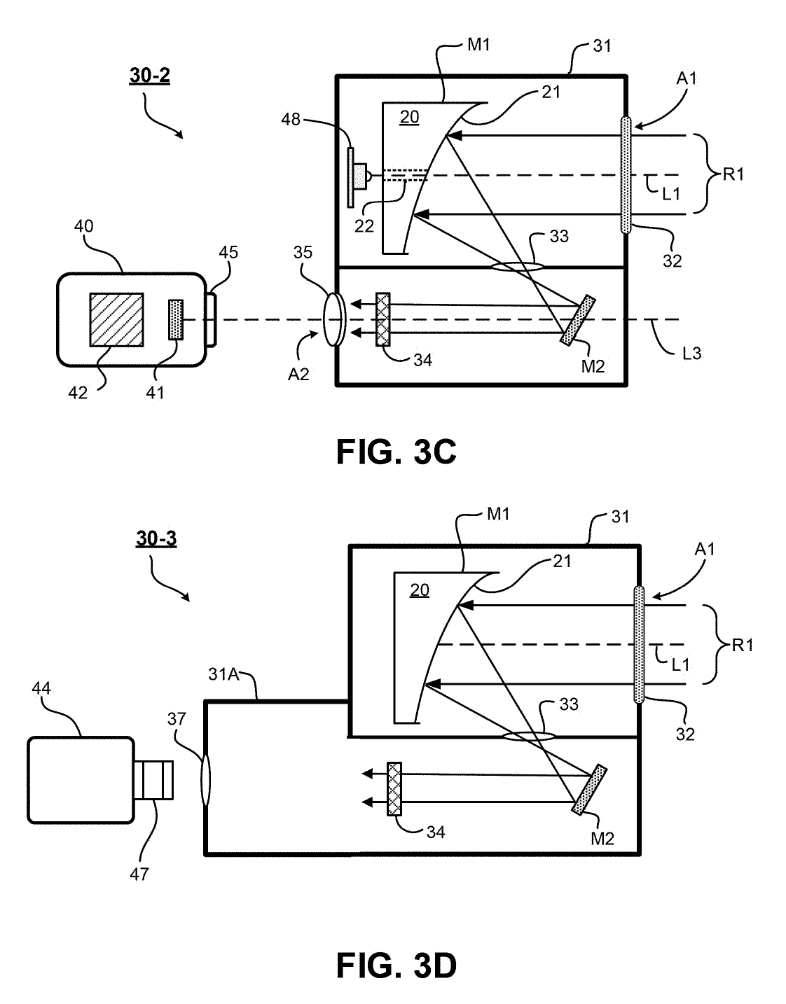

For outdoor applications, protective camera housings can be used outdoors and in harsh environments. For example, FIGS. 4A and 4B schematically illustrate an optical system in which the camera (44) of FIG. 31) and an optical lens assembly (304) are disposed in a protective housing (49) environmentally controlled or outdoor applications. FIG. 4A is a front perspective view showing an imaging device (44) with a conventional lens (47) and the optical lens device (30_4) disposed within the protective housing (49) with a protective window (49_2) in a sidewall of the housing (49) with a protective hood cover (49_1) over the window (49_2). The optical lens assembly (30_4) may have a framework similar to that of the device (30_3) of FIG. 31) wherein the lens assembly (30_4) is adapted to couple to the lens (47) of the camera (44) at a right-angle configuration. In this exemplary embodiment, the protective window (49_2) is formed over an opening in the sidewall of the protective housing (49) (as opposed to the input aperture (A1) of the lens housing (31), but wherein the input aperture (A1) is aligned to and facing the protective window opening (49_2). The hood (49_1) provide further protection from harsh elements such as sun, rain, snow, etc.

### Optical Systems Having Integrated Optics and Imagine Electronic

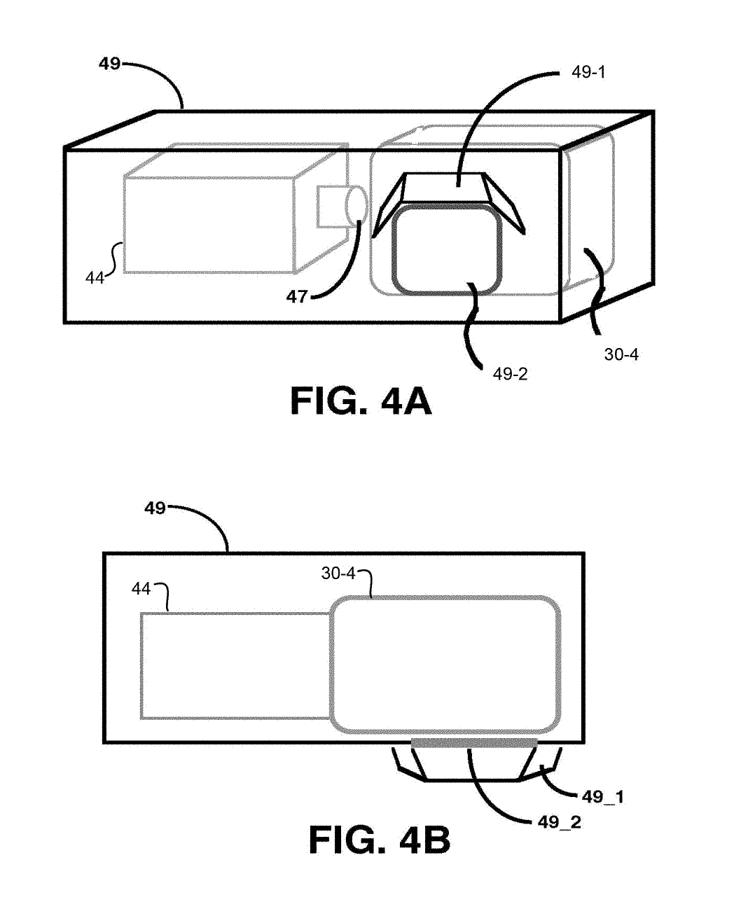

In other exemplary embodiments of the invention, wide spectrum optical systems and devices can be designed having first surface mirror optics and imaging electronics integrated within a common housing. For example, FIG. 5 schematically illustrates an optical device according to an exemplary embodiment of the invention in which optical systems and imager systems are integrated within a common housing. FIG. 5 schematically illustrates a high level general embodiment of an optical system (50) comprising a housing (51) with separate inner regions (51A) and (51B). The first region (51A) includes an OAP mirror (20) with centerline through hole (22) as a primary mirror (M1) similar to embodiments discussed above. The second region (51B) includes mechanical control systems (54) and imaging optics and electronics (55-59).

In the exemplary embodiment, the optical system (50) can support both on-axis and off-axis viewing. For example, incoming photonic energy reflected and focused by the primary OAP mirror (20) passes through a field stop opening (53A) providing an intermediate “off axis” image that can be directed by field optics (55) to one or more imagers (56) to capture an off-axis image in one or more spectral bands. In addition, incoming photonic energy can pass through the centerline through hole (22) and a second field stop opening (53B) in back of the mirror M1 providing an intermediate “on-axis” image that is directed by field optics (57) to one or more imagers (58) to capture an on-axis image in one or more spectral bands. The on-axis and/or off-axis images captured by the imagers (56) and (58) can be processed by optional image processing electronics (59) to generate and output an image of a target scene for different spectral bands. The control system (54) can be configured to mechanically control movement of internal field optics (55) and (57) or other components to provide various functions such as zoom or focus control.

In the exemplary embodiment of FIG. 5, by providing separate internal compartments (51A) and (51B), the internal imaging electronics can be effectively shielded from stray radiation that may be present in the input optical changer (51A). This is to be contrasted with conventional optical systems in which atomic radiation can pass easily through conventional lens materials used for UV through Far IR imaging damaging internal imaging devices and electronics. In FIG. 5, X-ray radiation may be contained and absorbed within the optical chamber (51A) by internal shielding (53). In addition, the primary off-axis mirror (20) can be made of materials that absorb radiation where the front surface materials formed on the reflective surface (21) are so thin that they will have almost no effect on the radiation but will effectively perform the optical purpose of the off axis mirror. Any scattered radiation can be mitigated by material used for protective windows on the openings (53A) and (53B) (e.g., PbSe) so that any scattered radiation does not reach the imagers (56) and (58).

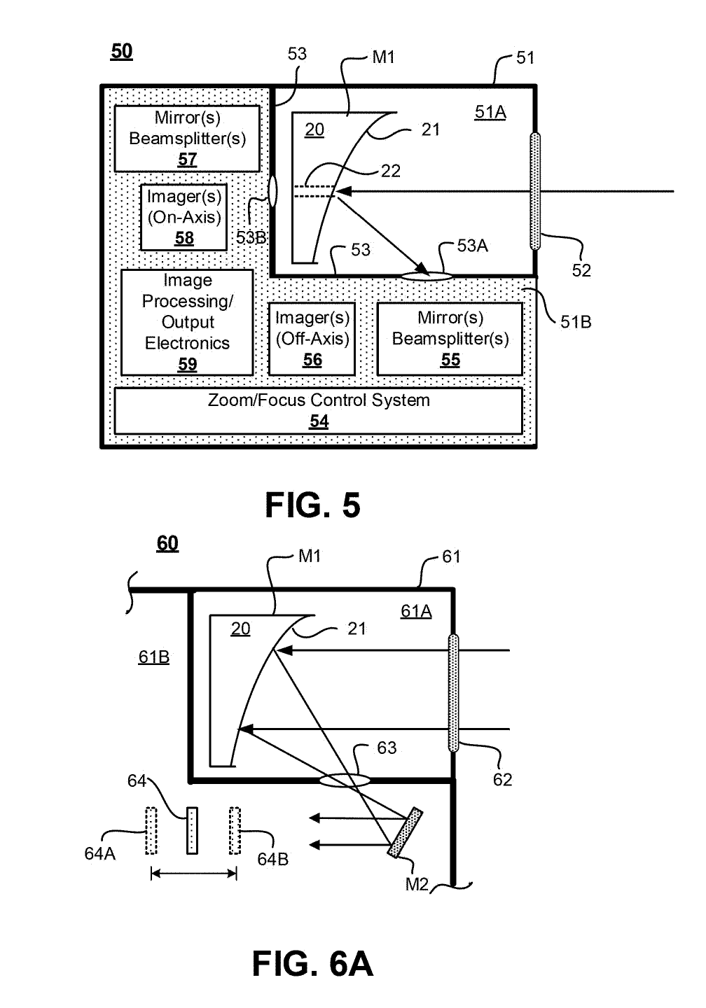

It is to be understood that FIG. 5 depicts a general exemplary embodiment of various internal components that may be integrated, optionally, within a common housing and various frameworks can be designed based on the general framework. For example, FIGS. 6A-6D illustrate exemplary embodiments of optical devices with integrated optics and imagers providing zoom and focus control. In particular, FIG. 6A schematically illustrates an optical device (60) according to an exemplary embodiment of the invention comprising a housing (61) with separate inner regions (61A) and (61B). The first region (61A) includes an OAP mirror (20) as a primary mirror (M1) and the second region (618) includes field optics including a secondary first surface mirror M2 and an imager (64). Incoming photonic energy from a target scene which passes through the protective window (62) is reflected and focused by the primary mirror M1 through a field stop opening (63) providing an intermediate “off axis” image that can be redirected by secondary mirror M2 to the imager (64) (e.g., focal plane array). The imager (64) can pass image data to internal or external image processing electronics (not shown) that create a viewable video signal for output to a display system (not shown). FIG. 6A illustrates the use of a back-focus adjustment for moving the imager (64) back and forth to a position between or at end points 64A and 64B to vary the distance from a last optical element (e.g., M2) from the imager focal plane so as to accommodate focusing at different image distances as well as for the requirements of the different imager sizes and camera mount sizes.

FIG. 6B illustrates an optical device according to another exemplary embodiment of the invention having optics and imager devices integrated within a common housing. In particular, FIG. 6B illustrates an optical device (60_1) similar to the device (60) in FIG. 6A, but wherein a secondary mirror (M2) is spherical first surface mirror that magnifies and reflects an intermediate off-axis image to a pivotable imager device (64). This exemplary embodiment provides optical zoom by moving the secondary mirror M2 within the image path between the main mirror ML and the imager (64) to vary the magnification factor and affect the field of view (FOV). This configuration provides zoom functionality as follows. The primary mirror (M1) generates an intermediate off-axis image directed at the secondary first surface mirror (M2 which magnifies the image and directs the magnified image to the imager (64). The position of the secondary mirror (M2) can move closer to and further from the imager (64) to achieve zooming operation. The imager (64) is pivoted (via a suitable mechanical control mechanism) so that the optical axis of the secondary mirror (M2) remains orthogonal to the surface of the imager (64) (as illustrated by alternate positions 64′ and M2′ of the imager (64) and mirror (M2)). The imager (64) passes the image data to internal or external imager electronics (not shown) that create a viewable image signal. The optical device (60_1)) can be configured for on-axis viewing when a centerline through hole is included in the primary mirror (M1) and incorporated field optics and imager electrons as desired within internal region (61B).

In other exemplary embodiments of the invention, variable zoom functionality of FIG. 6B can be achieved by selectively changing the secondary mirror M2 and keeping the imager (64) using slider or wheel mechanisms having different parabolic first surface mirrors to provide an incremental variable magnification zoom function, such as depicted in FIGS. 6C and 61). In particular, FIG. 6C illustrates a rotating wheel mechanism (65) having a plurality of parabolic mirrors M2a, M2b and M2c with different surface curvatures. FIG. 6D illustrates a front and side view of a rectangular slider mechanism (66) having the different parabolic mirrors M2a, M2b and M2c. To access different increments of zoom magnification, a user could manually operate the wheel (65) (rotate) or slider (66) (slide) to selectively place one of the parabolic mirrors M2a, M2b or M2c in the position of the secondary mirror M2 (FIG. 6B) to achieve a desired magnification. In other embodiments, the rotation or sliding operation can be automated using a motor or solenoid and controlled remotely.

As the magnification increases, the FOV (field of view) narrows with the effect that objects in the distance are enlarged and appear bigger or with more detail. Lower magnification is provided as the concave shape of the parabolic mirror become flatter and higher magnification is achieved as the concave shape of the parabolic mirror becomes deeper. The slider (66) and wheel (65) can be molded out of plastic, glass, ceramic or metal. The reflective surface and the appropriate protective and optical enhancing layer coatings as discussed above can be applied to the parabolic mirror first surfaces. The number of selectable mirrors on a given wheel or slider can vary depending on the space available or level of granularity desired or acceptable.

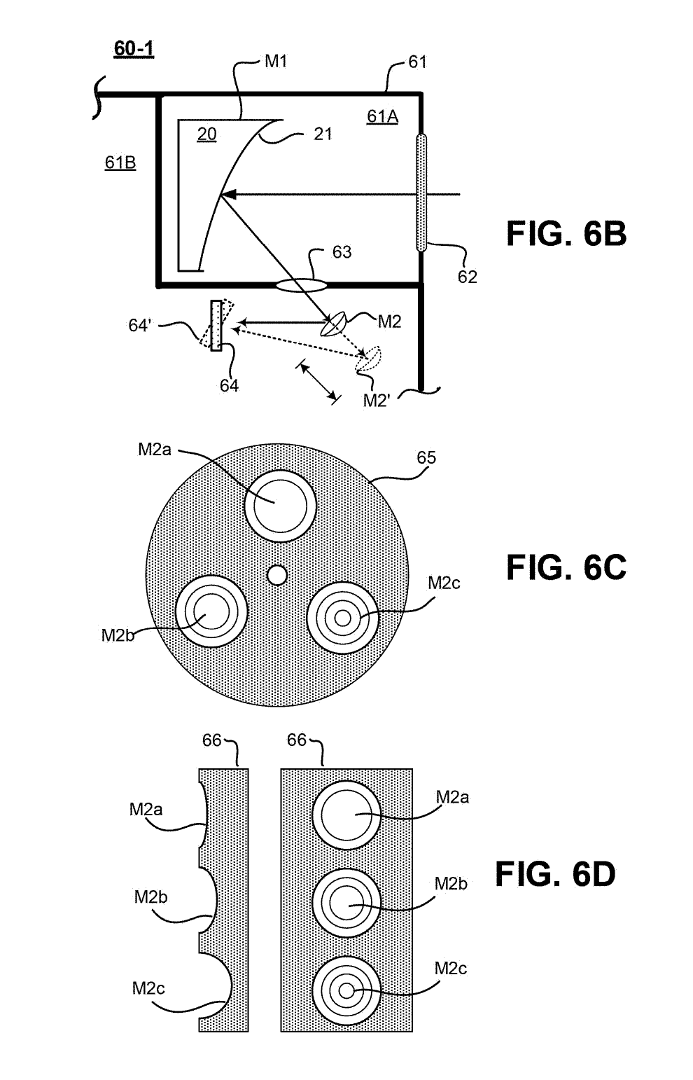

FIGS. 7A-7C schematically illustrate optical devices according to other exemplary embodiments of the invention based on the general framework of FIG. 5 in which multiple imagers are employed to capture an image of a target scene in different spectral bands. In particular, FIG. 7A schematically illustrates an optical device (70) according to an exemplary embodiment of the invention comprising a housing (71) with separate inner regions (71A) and (71B). The first region (71A) includes an OAP mirror (20) as a primary mirror (M1) and the second region (71B) includes field optics including a secondary first surface mirror M2, a first imager (74) and a second imager (75). Incoming photonic energy from a target scene which passes through the protective window (72) is reflected and focused by the primary mirror M1 through a field stop opening (73) providing an intermediate “off axis” image that can be redirected by secondary mirror M2 to both imagers (64) and (65) (e.g., focal plane arrays). The secondary mirror (M2) is pivotally controlled to pivot between two or more different positions (as shown by M2 and M2′) to redirect the focused image coming from the primary OAP mirror (20) to one of the different imagers (74) and (75)

In the exemplary embodiment of FIG. 7A, the optical device (70) can be designed for wideband operation at wavelengths from UV to IR (from 1 nm to 30 μm), where the primary mirror (M1) is adapted to provide wide spectrum, low loss reflection over multiple spectral bands, while the different imagers (74) and (75) can be incorporated in the same camera body and electrically switchable to different wavelength receivers. For instance, the first imager (74) may be designed to detect photonic energy with a wavelength in the range of 8-14 microns, while the second imager (75) may be configured to detect photonic energy with a wavelength in a range of 0.2˜0.75 microns or 0.8˜1.2 microns, for example. In this regard, imagers with different characteristics (such as hi and lo sensitivity or different pixel configurations) can be packaged in the same body (71) and switched as needed (e.g., night and day use). In another embodiment, a fast moving stepper motor can be used to move the image from one imager to another within the video systems frame rate to seemingly have the image captured by each imager (74) and (75) simultaneously (almost real time).

In addition, imager selection can be implemented to select redundant imagers in case of imager damage. Very often, an imager can become damaged by high energy radiation incident thereon which damages pixels (e.g., reflection from bright sun, an explosion, search lights, etc.). If an imager is damaged, the exemplary configuration of FIG. 7A could be configured to sense the damaged imager and pivot the secondary mirror M2 to aim the incoming scene to a redundant imager for the given spectral band. In other embodiments, the secondary mirror (M2) may be a spherical mirror (for a zoom configuration) that can be pivoted to perform the same function. The secondary mirror (M2) can be made to pivot in X and Y planes to aim at one of a plurality of different imagers arranged in a hemispherical layout. The imagers (74) and (75) can output image data to internal or external image processing electronics (not shown) that create a viewable video signal for output to a display system (not shown). The optical device (70) can be configured for on-axis viewing when a centerline through hole is included in the primary mirror (M1) and incorporated field optics and imager electrons as desired within internal region (71B).

FIG. 7B schematically illustrates an optical device according to another exemplary embodiment of the invention having optics and imaging electronics integrated within a common housing. In particular, FIG. 7B illustrates an exemplary embodiment of an optical device (70_1) which is similar to that of FIG. 7A, except that a beam splitter (B1) is used in place of the secondary mirror (M2) so as to direct different spectral components of the intermediate off-axis image to the imagers (74) and (75) simultaneously in real time without having to pivot a secondary mirror (M2). In this configuration the beam splitter (B1) can also be used to separate specific wavelengths of incoming energy like visible and IR, etc. The imagers 74 and 75 can be configured to capture images of photonic radiation different spectral ranges (i.e.: visible and Far IR).

FIG. 7C schematically illustrates an optical device according to another exemplary embodiment of the invention having optics and imaging electronics integrated within a common housing. In particular, FIG. 7C illustrates an exemplary embodiment of an optical device (70_2) which is similar to that of FIG. 7B, but further includes a second beam splitter (B2) positioned at the back surface of the primary mirror (M1) to receive incident radiation of an on-axis image that passes through the through-hole (22) of the primary mirror (M1) along the optical centerline. The second beam splitter (82) splits the on-axis image into components that are directed to additional imagers 76 and 77.

The exemplary embodiments of FIGS. 7A-7C allow an image of a scene to be captured in different spectral bands, wherein system software can integrate the different spectral images as desired to enhance the captured image. For example, a target image in the visible spectral band which is captured at night or in low light conditions may be enhanced using IR image data. The imager can also separate the two scenes with software and give alternating frames of IR and visible video, or give two real time separate IR and visible signals from two outputs. The system can interpolate and enhance the video by proportionally mixing the two images. In other exemplary embodiments, a single, dual spectrum imager can be used to facilitate dual superimposed images of a target scene in two spectral sub-bands, such as visible and IR in real time.

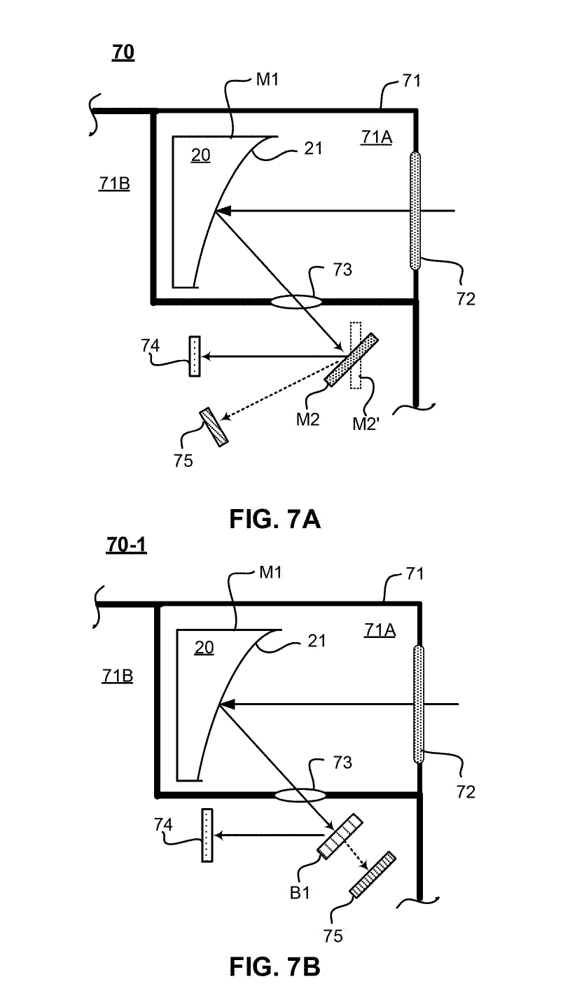

FIG. 8 schematically illustrates an optical device according to an exemplary embodiment of the invention in which heat sink components (80) are used to provide active cooling of a primary OAP mirror (20). In some applications and under some environmental conditions, it is advantageous to maintain the optical mirror (20) at a constant or controlled temperature to help maintain image integrity and consistency. The constant temperature will keep the primary optic (20) from changing size or shape due to temperature change, which would distort the image and contribute to degraded image quality. In particular, for thermal imaging applications, it is advantageous for the optical elements to be temperature controlled so as to not affect the incoming incident scene photons and help keep the systems sensitivity consistent. Indeed, under conditions where the ambient temperature is higher than the optimal operating temperature of the cameras imager and electronics, cooling the optical elements will help keep the ambient heat from ‘swamping’ the image photons at the imager or causing the system to lose sensitivity. It would otherwise perceive the heat coming off the optics as thermal noise which would obscure the scene photons in the thermal noise floor.

In FIG. 8, a heat sink device (80) can be thermally coupled to the back surface of the OAP mirror (20), wherein the heat sink (80) comprises a TE (thermo-electric) cooler device (81) and a heat sink (82). The TE device (81) can be controlled such that a first surface thereof coupled to the mirror (20) is “cool” while the second surface thereof that is coupled to the heat sink (82) is “hot”. The heat sink (82) can serve to dissipate heat from the hot surface of the TE device (81). For on-axis viewing, a through hole (83) can be formed through the heat sink (80) in alignment with the centerline through hole (22) of the mirror (20).

### Laser Targeting and Distance to Target Applications

In other exemplary embodiments of the invention, various optical systems and devices can be implemented using the conceptual framework discussed above with reference to FIG. 21), for example, to accommodate CLTD (centerline target designator) functionality in wide spectrum applications. As noted above, a laser source can be used to emit a laser beam over the optical centerline (L1) without interfering with the viewed scene or its image. The use of a centerline through hole (22) in an off-axis parabolic mirror for laser dot target designation or for identification of the centerline of the systems view is a novel design providing a simple and extremely inexpensive optical configuration permitting real time direct (not optically added with mirrors, prisms or beam splitters) viewing of an illumination type target designation device. By having the laser spot come from the main mirror, alignment and mount of the laser to the system is readily achieved.

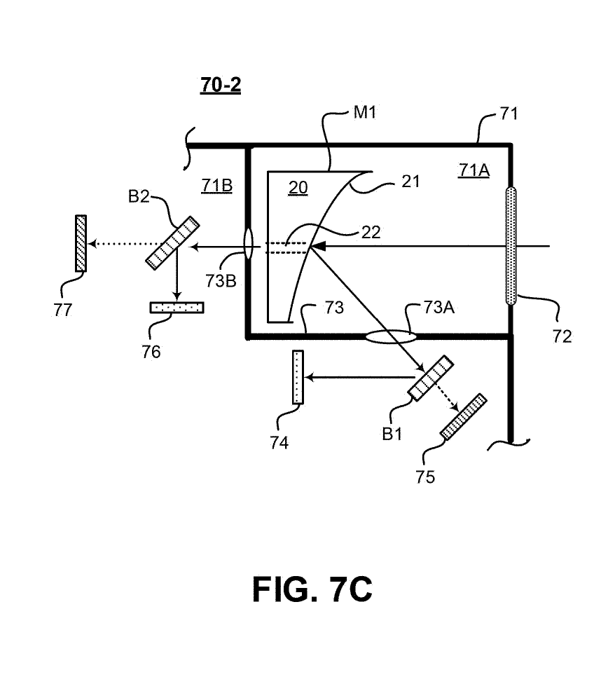

FIG. 9A schematically illustrates an optical device (90) according to an exemplary embodiment of the invention for CLTD (centerline targeting designator) applications. The device (90) comprising a housing (91) with separate inner regions (91A) and (91B). The first region (91A) includes an OAP mirror (20) as a primary mirror (M1) and the second region (91B) includes field optics including a secondary first surface mirror M2 and optionally image capture and processing electronics (96). A laser beam source (94) is mounted to the lens housing (91) (either internally or external) in alignment with a small aperture (94) in the housing (91) and the through-hole (22) of the primary mirror (20) so as to emit a laser beam (b1) that can pass through the small aperture (94) and through-hole (22) along the optical centerline of the OAP mirror (20) towards a target scene T. The laser beam travels out over the same optical centerline of the incoming image and forms a laser dot spot(s) on the target object T aligned to the optical centerline of the mirror (M1) (and consequently, the centerline of the main mirrors image).

The laser spot(s) and target T can be viewed in real time in an image displayed on a monitor (97). Incoming photonic energy from the target scene T passing through the protective window (92) is reflected and focused by the primary mirror M1 through a field stop opening (93) providing an intermediate “off axis” image that can be redirected by secondary mirror M2 to an internal or external imager. In the exemplary optical device, since the primary mirror (M1) directs the image of the target scene off-axis, the area in front of the main mirror (20) is unobstructed. Moreover, since the through-hole (22) is preferably formed with a small diameter (e.g., 1 to 5 mm in diameter), the laser beam can be readily passed through the centerline hole (22) of the mirror (20) and the hole will not have any significant effect on the overall image.

The embodiment of FIG. 9A can be modified wherein the laser (95) is mounted perpendicular to the optical centerline and where the laser beam is reflected into the through hole (22) of the primary mirror (20) using a small flat front surface mirror mounted at a 45° angle in back of the mirror (20).

FIG. 9B schematically illustrates an optical device according to another exemplary embodiment of the invention which is designed for targeting designator and distance to target precision measurement applications. FIG. 9B schematically illustrates an optical device (90_1) similar to that of FIG. 9A, but wherein CLTD is implemented using multiple lasers (95_1) and (95_2) of different wavelengths. A beam splitter (98) can be used to combine a laser beam (b1) from laser (95_1) and a laser beam (b2) from the laser (95_2) to form a laser beam (b3). In this configuration, two targeting lasers are arranged on the back side of the OAP mirror (20) and emit different laser beams (b1, b2) that are superimposed into laser beam (b3) using a beam splitter (162) and transmitted through the hole (22) of the primary mirror (20) towards a target scene over the same optical centerline of the returning images. The optical device, while also allowing imaging of the same optical centerline by one or more imagers of visible, near IR or thermal ranges, also produces targeting spots of two different wavelengths at the same time on the same spot on a target scene (e.g., Visible, 4 microns, 10 microns). In another exemplary embodiment, the laser (95_1) in FIG. 9B, for example, can be replaced with a pin hole camera or lens to enable real time visible bandwidth viewing over the same optical centerline.

FIG. 9C schematically illustrates an optical device according to another exemplary embodiment of the invention which is designed for targeting designator and distance to target precision measurement applications. FIG. 9C illustrates an optical device (90_2) that is similar to that of FIG. 9A, but the external laser (95_2) is pivotally mounted on the housing (91). The external laser (95_2) can be pivotally controlled by a motorized system and run by a μC with digital readout superimposed in the video display (97). The fixed laser (95_1) emits a laser beam (b1) along the optical centerline while the second laser (95_2) emits an off-axis laser beam (b2) which produces two different laser dots (s1) and (s2) on the target (1) in the scene. To acquire the distance to target, the second laser (95_2) is pivoted on axis until the dots (s1) and (s2) coincide, wherein the distance can then be directly read out on a scale (99) or by the systems μC. The distance can be computed as: the distance in meters=tan (X °)/1 where X=to the number of degrees the laser was moved off centerline until the two beams coincide. The housing (91) can have either a degrees scale or a distance scale (99) calibrated for direct reading. If sensors or stepper motors are used the systems μC can do the computations and read out in the video or other conventional display.

In another exemplary embodiment, if the external laser (95_2) is fixed, the focus position or magnification of the lens arrangement and the number of pixels between the dots can be used as the measurement system. This system can accommodate multiple imagers of different wavelengths so multiple frequency lasers can be used to accommodate different target and measurement requirements from various real world conditions.

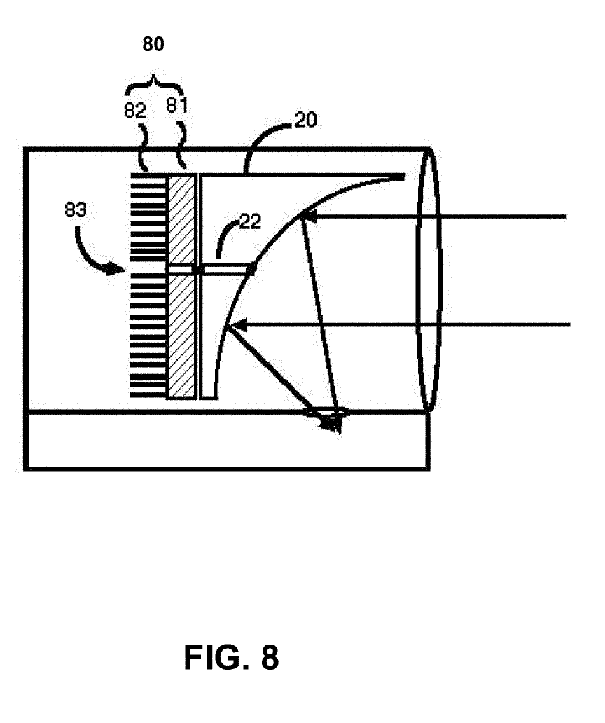

FIGS. 10A, 10B and 10C schematically illustrate an optical device according to another exemplary embodiment of the invention which is designed for targeting designator and distance to target precision measurement applications. FIG. 10A illustrates an optical device (100) having a primary OAP mirror (20) within a housing (101) and two fixed lasers (104) and (105) mounted on the back of the device housing (101) to emit laser beams b1 and b2, respectively, in the exemplary embodiment of FIG. 10A, the housing (101) has two small apertures h1 and h2, and the primary OAP mirror (20) has two through holes 24 and 25 that are formed through the mirror substrate between the front and back surfaces outside the “clear aperture area” of the primary mirror (20). The housing apertures (h1) and (h2) are aligned to the through holes 24 and 25, respectively. The laser beam (104) is fixedly mounted to emit a laser beam (b1) that passes through the aperture (h1) and through hole (24) while the laser beam (105) is mounted to emit a laser beam (b2) that passes through the aperture (h2) and through hole (25), to thereby form two laser dots (s1) and (s2) on a target T. As the through holes (24) and (25) are in fixed positions relative to each other and the optical centerline of the mirror (20), the laser dots (s1) and (s2) formed by laser beams b1 and b2 on a target will always appear on the same horizontal line in an image of target displayed on monitor (120). Therefore, the number of pixels between the laser dots can be used to approximate the distance to the target. A scale can be drawn on the monitor screen or superimposed in the video to indicate distance, or the microcontroller can locate the dots and compute the distance from the number of pixels between the dots and the zoom factor or magnification.

In the exemplary embodiment of FIG. 10A, the targeting laser holes (24) and (25) do not affect the system image as they are formed outside the “clear aperture area” of the primary OAP mirror (20) that are outside the usable image area. All optics, mirrors and lenses have a usable area measured from the center of the optic towards the outside. If one attempts to image at the outer portions of a conventional optic the distortion becomes intolerable, as the outer area is not usable for proper focusing. The usable area is called ‘the clear aperture area’ (CAA). For instance, FIG. 101 schematically depicts a front side view of the reflective surface (21) of the OAP mirror (20) in FIG. 10A, wherein the surface includes an inner surface region (21a) which is the clear aperture area and an outer peripheral region (21b) outside the clear aperture area (21a). The through holes (24) and (25) are formed in the region (21b) outside the CAA. In this embodiment, the holes (24) and (25) will not interfere with the image within the usable portion of the CAA (21a). In some embodiments, two or more holes can be formed in the mirror substrate in the region (21b) outside the CAA (21a) to facilitate simultaneous functions of many lasers and pin-hole viewers and cameras.

In some embodiments in which a protective cover (102) is used over the front aperture (A1) to protect the internal components, holes can be formed as windows in the protective cover, which are aligned to through holes of the primary OAP mirror, whereby the holes are filled with appropriate insert material that is transparent to the spectrum being used for the particular purpose. For example, as shown in FIGS. 10B and 10C, a protective cover (102) for the optical device (100) of FIG. 10 may be formed with windows (w1) and (w2) that axially align to corresponding through holes (24) and (25) in the mirror (20). The windows (w1) and (12) can be filled with material that allows lossless or low loss transmission for the given wavelength of photonic energy that passes through that window region of the cover (102), while allowing the portion of the cover (102) aligned to the CAA of the mirror (20) to be designed for the given spectral bands for imaging.

In another exemplary embodiment of FIG. 10A, the two external fixed lasers (104) and (105) can be mounted on opposite sides (top and bottom) of the device housing (101) to emit laser beams that do not pass through the primary mirror (M1). In this embodiment, the two lasers can be fixedly spaced apart at a greater distance so they can be used to target and measure at greater distances. In other embodiments, the spacing between lasers can be variable.

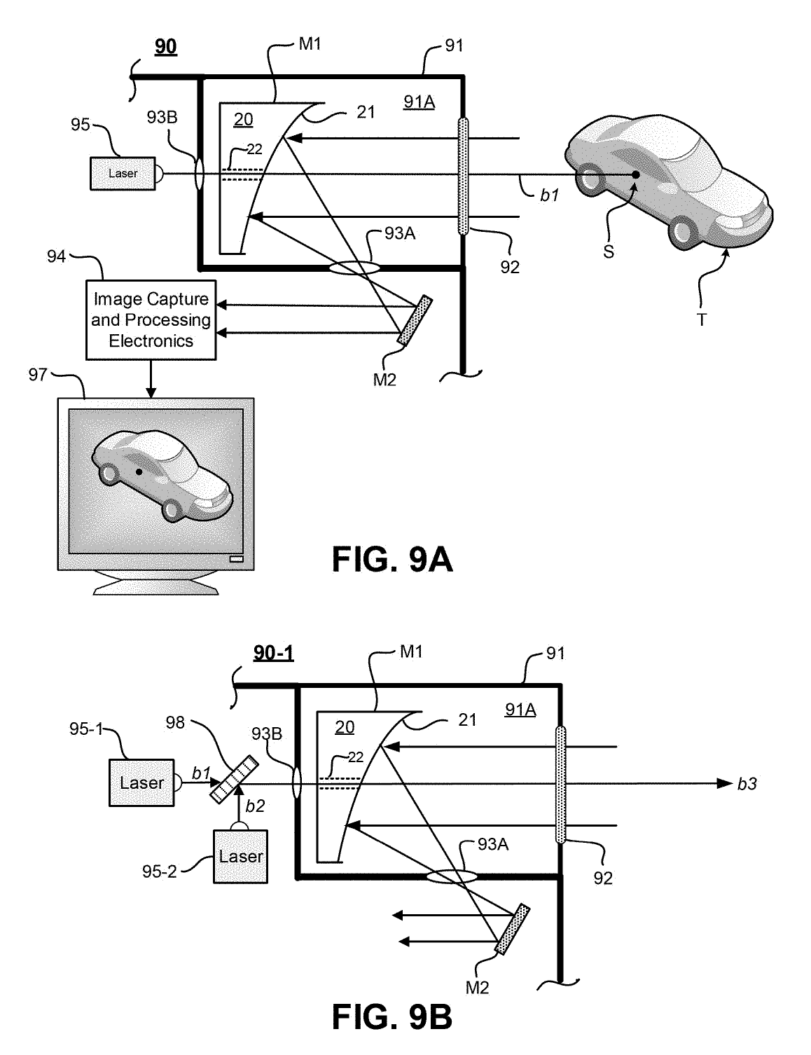

FIG. 11 schematically illustrates an optical system according to another exemplary embodiment of the invention which is designed for targeting designator and distance to target precision measurement applications. FIG. 11 illustrates an optical device (110) comprising a housing (111) in which a primary OAP mirror (20) reflects incident photonic radiation passing through the optical input (112) and focuses the reflected rays through field stop window (113) to an imager (114). The device (110) further includes two internal offset lasers (115) and (116) for targeting and distance measurement applications. The exemplary device (110) operates similar to those discussed above with similar layouts whereby two off-axis targeting or distancing lasers (115) and (116) emit laser beams (b1) and (b2) that pass through apertures (115a) and (116a) and reflected by the front reflective surface (21) of the primary OAP mirror (20). The two different lasers (115) and (116) may emit laser beams of different wavelengths. If the lasers are movable, then they can follow multiple targets that stay within the view of the optic. One laser beam (b1) can light up a target and the other laser beam (b2) can designate friendly forces.

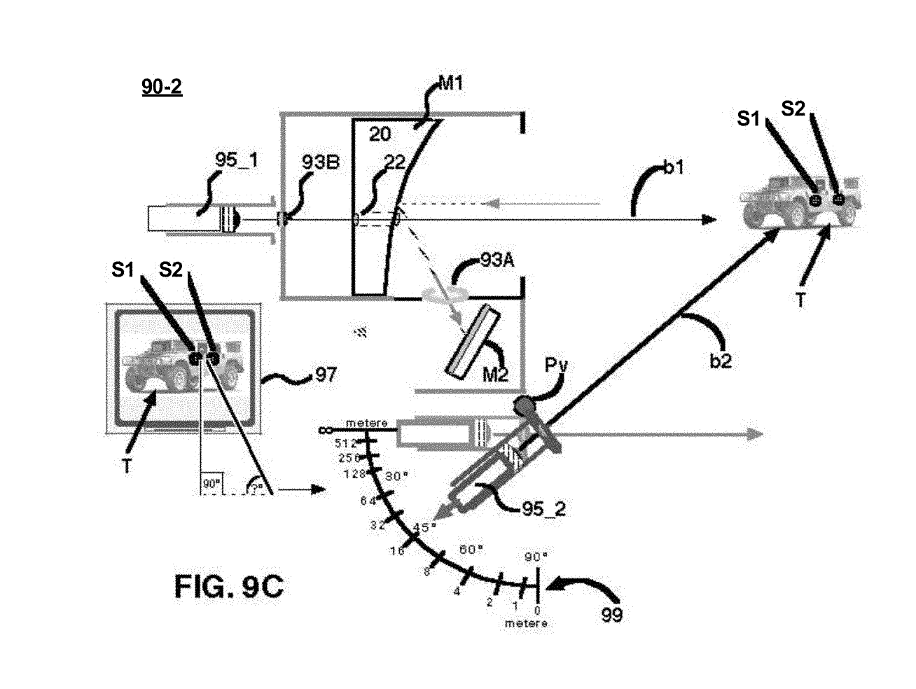

FIG. 12 schematically illustrates an optical system according to another exemplary embodiment of the invention for targeting designator and distance to target precision measurement applications. FIG. 12 illustrates an optical device (120) that comprises a primary OAP mirror (20) within a housing (121) that reflects incident photonic radiation passing through an input window (122) and focuses the reflected rays through field stop window (123) to a secondary mirror (124). A laser beam source (125) is disposed behind the secondary mirror (124). In this embodiment, a targeting laser beam (b1) emitted from the laser (125) passes through a through hole (124a) of the secondary mirror (124) and field stop window (123) toward the surface (21) of mirror (20), wherein the beam is reflected out to the scene along the optical centerline of the OAP mirror (20) for targeting or distance measurement. The incoming photonic radiation of the scene can be focused by mirror (1), re-directed by reflection from the secondary mirror (181) and processed as discussed above (e.g., sent to an imager or can be viewed by eye in real time).

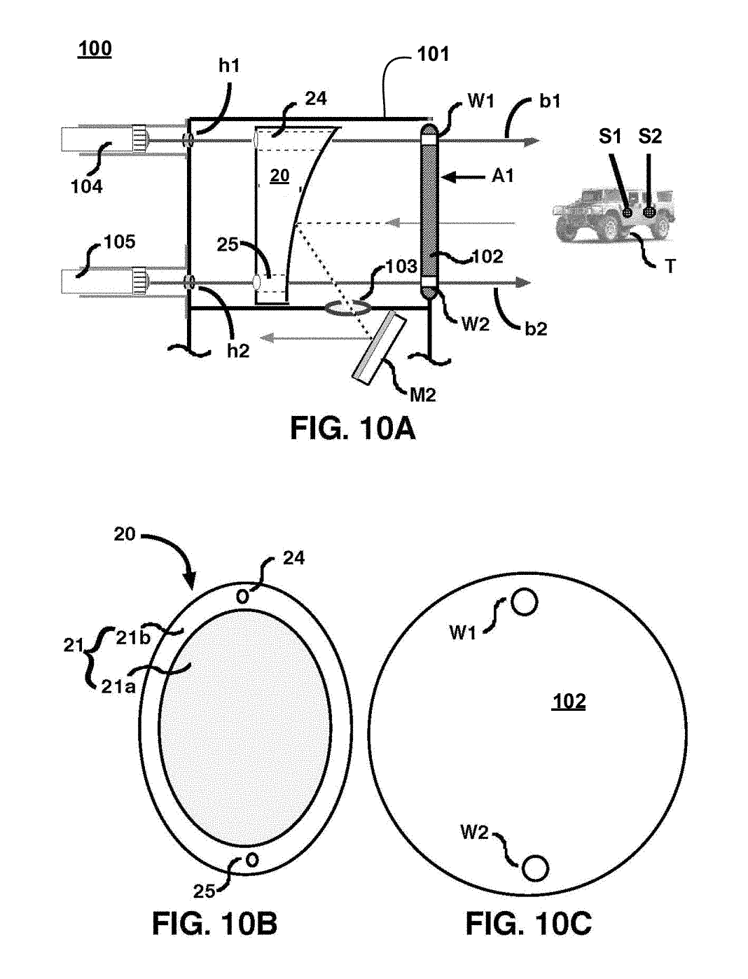

FIGS. 13A and 13B schematically illustrate optical systems according to exemplary embodiments of the invention in which a primary OAP mirror (20) with a centerline through hole (22) can be implemented for LADAR (Laser Radar) applications. In general, LADAR is employed similar to millimeter wave radar, but uses laser beams to scan a target area and process the signal echoed from target to create an image of the target area. In FIG. 13A, a LADAR system (130) comprises a first surface OAP mirror (20) with a centerline through hole (22), and a scanning laser device (131) that emits a scanning laser beam that passes through the hole (22) and out towards a target area TA which is scanned by the emitted laser beam. The centerline hole (22) facilitates on-axis alignment of the emitted laser on the optical centerline of the system. Simultaneously, incoming photonic radiation from the scanned target area is reflected and focused off axis to a suitable imager/detector (132) and processed to generate an image of the scanned target area.

FIG. 13B is another exemplary embodiment of a LADAR system (130_1) comprising a first surface OAP mirror (20) with a centerline through hole (22), and a scanning laser device (131) that is disposed “off-axis” and emits a scanning laser beam directly at the reflective surface (21) of the OAP mirror which is reflected to a target area that is scanned. A pin-hole camera (133) is disposed behind the mirror (20) and is used as the receiving imager for on-axis viewing of photonic radiation comprising high energy narrow spectrum photons that are reflected back from the scanned target area.

### Boroscopic Optics

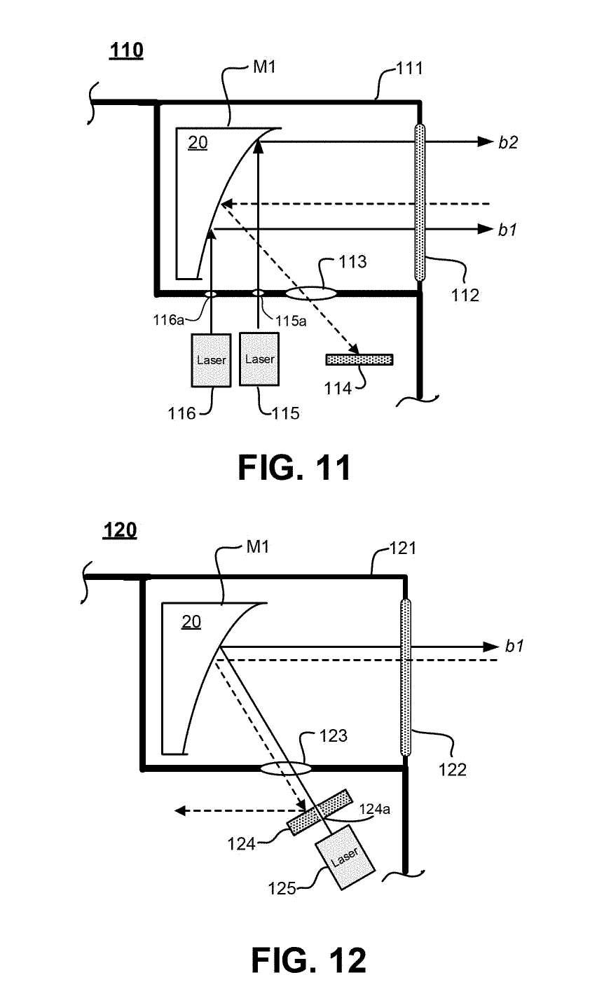

FIGS. 14A and 141B schematically illustrate optical devices according to exemplary embodiments in which boroscopic optics or optical tubes are incorporated as part of a primary OAP mirror to implement multispectral imaging applications. FIG. 14A schematically illustrates an optical device (140) according to an exemplary embodiment of the invention comprising a housing (141) with an OAP mirror (20) as a primary mirror (M1), a protective cover (142) and field stop opening. FIG. 14A illustrate the use of a rigid 0 degree boroscopic optic (144) inserted through the through-hole (22) of the primary mirror (20) and extending to the back of the protective cover (142) to enable direct viewing or on-axis imaging of incident radiation of a target scene along the optical centerline of the OAP mirror (20). The boroscopic device (144) can be made from gemological materials to operate in the IR band, made from KCl, CaF2 etc., to provide wide spectrum operation, or made from glass or plastic to perform in the visible band. In other words, depending on the material that is used to form the boroscopic device (144), it can be used for wide spectrum or narrowband operation.

FIG. 14B is another exemplary embodiment of an optical device (140_1) using a boroscopic device (147) similar to FIG. 14A but with an illumination source (146) being used to focus outward illumination of the target scene or object of interest. With the implementation of the Boroscope (147) a source of wide field illumination can be achieved. Again, the material of the Boroscope (147) can be selected to facilitate the needed spectral bandwidth. For example, if a Near IR imager is used (1 micron), the scene can be illuminated with an appropriate light source and the Boroscope (147) can be made from a material that will pass the 1 micron light.

In exemplary embodiments of FIGS. 14A and 14B wherein the optical device has a protective window cover (142), the main portion (142a) can be formed to have optical characteristics as desired while a small window (142b) of an appropriate spectral band can be formed into an appropriate spot on the front protective window (142) having optical characteristics suitable to the spectral band of operation of the boroscopic optics being implemented (which can be UV, visible or IR). This allows simultaneous viewing at two different spectral bands and/or at different FOVs or distances. As shown in FIGS. 14A and 14B, each boroscopic device 144 and 147 extends along the optical centerline to a point just in back of the protective window (142) in line with the small window (142b) to enable on-axis viewing of the target scene.

In other exemplary embodiments, a rigid hollow tube (straight or tapered) can be used instead of a Boroscope. The hollow tube (91) will provide a 1:1 pin-hole type view of the scene. The tube can be pushed up against the secondary window insert (142b) to cause a minimum obscuring of the main scene view through the primary mirror (1). As with previous designs, the tubes allow viewing from the back of the primary mirror (20) by eye or by camera along the optical centerline. Moreover, a laser or other source of illumination can be sent out from the back of the primary mirror through the hollow tube. The hollow tube may be tapered to achieve a higher FOV as compared to the straight tube.

### Photonic Bi-Directional Secure Laser Communications (BDLC) Applications

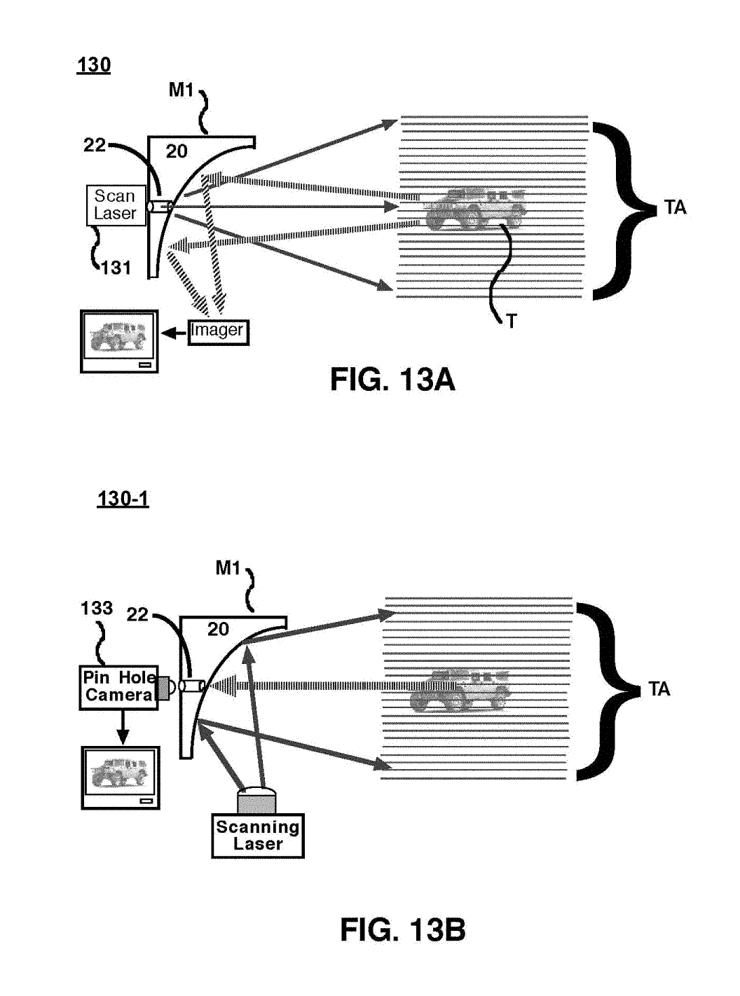

FIGS. 15A and 15B schematically illustrate optical systems according to exemplary embodiments of the invention in which a first surface OAP mirror (20) with a centerline through hole (22) can be implemented for photonic BDLC (Bi-Directional Secure Laser Communications) applications. In particular, FIGS. 15A and 15B illustrate the use of first surface OAP mirror (20) with a centerline through hole (22) to implement line of sight secure communications systems suitable for voice, video or data. The optical devices with OAP mirrors (20) with centerline through holes (22) allow easy configuration and alignment between two stations using real time video or eye viewing to aim two opposing optical systems. Once the second system is aimed at the first, communication can commence.

FIG. 15A schematically illustrates a BDLC system (150) providing full duplex operation between two optical systems (150A) and (150B) each comprising an OAP mirror (20) with a centerline through hole (22), and a corresponding data laser device (151A/B) and detectors (152A/B). The data lasers (151A/B) can transmit data to opposing optical systems (150A, 150B) via laser beans that are emitted “on-axis” along the optical centerlines of the OAP mirrors (20). The detectors (152A/B) are used to detect laser data from off-axis laser energy reflected from the OAP mirrors (20) suitable for the laser light wavelength used. Since the OAP mirrors (20) are wide spectrum, real time viewing in the visible spectral band can be implemented simultaneously with data communications in another spectrum like Near IR or Far IR so the beam is not detectable in the visible.

For instance, FIG. 15B schematically illustrates a BDLC system (150_1) similar to that of FIG. 15A, except that the optical system (1508) includes a beam splitter (153) and imager (154). The OAP mirror (20) in system (150B) reflect scene image and data to the beam splitter (153) which passes the laser data photonic energy to the detector (152B) while reflecting other photonic energy to the image (154). This embodiment scene view, CLTD, multispectral imaging and real time scene view by camera or by eye. The imager (154) can be used to visualize and lock in on the down field laser and then dial in the detector (152B) for communications. By using the beam splitter (153), as soon as the laser is visible in the imager (154) communications can be initiated. The image can also be used to actively maintain the laser locked in if the systems are in motion.

### Remote Reading IR Thermometer Applications

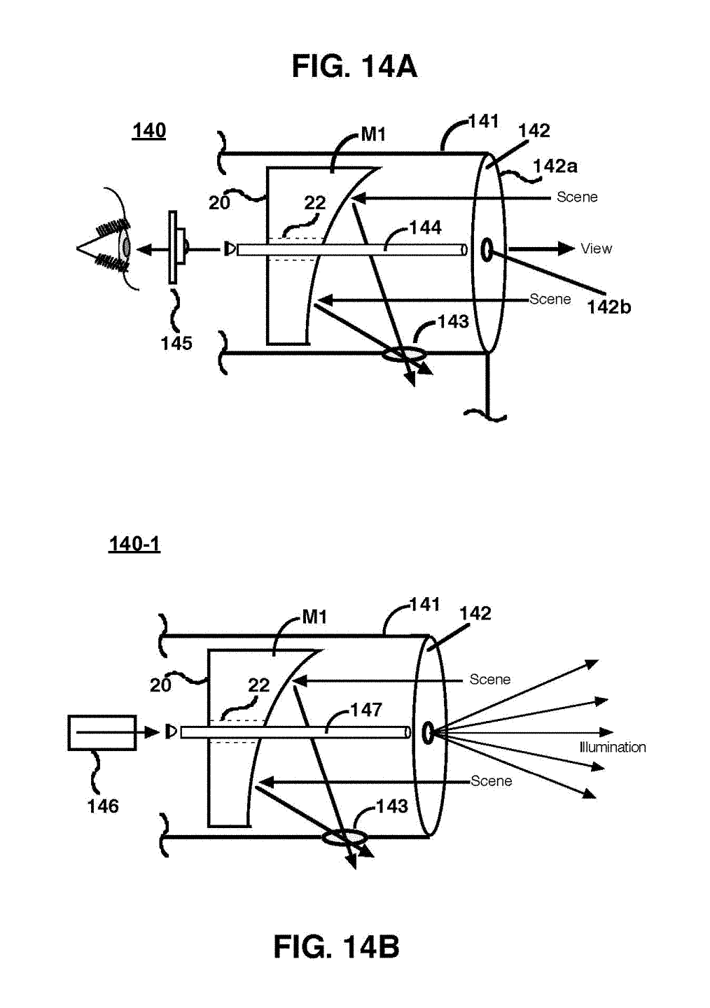

FIGS. 16A-16E schematically illustrate optical systems according to exemplary embodiments of the invention in which first surface mirrors are used in conjunction with lasers to implement remote reading IR thermometer systems. For example, FIG. 16A schematically illustrates an IR thermometer system (160) comprising an OAP mirror (20) with a centerline through hole (22), a laser device (161) and an JR thermometer device (162). The laser device (161) disposed in back of the OAP mirror (20) emits a laser beam that passes through the centerline hole (22) and travels “on-axis” along an optical centerline of the OAP mirror (20) to a target object (T) to generate a laser spot (S) on (or near) a target point of the target object (T) being sensed for temperature. The OAP mirror (20) reflects and focuses returning IR thermal energy “off-axis” to the IR thermometric detector (162) which makes a temperature measurement. The temperature information from the scene corresponds to the point at which the laser beam spot(s) is aimed at the target object (T) along the optical centerline.

FIG. 16B schematically illustrates an IR thermometer system (160_1) according to another exemplary embodiment of the invention. The system (160_1) includes an OAP mirror (20) having two through holes (h1) and (h2), two lasers (161) and (163) and detector (163), wherein the two holes (h1) and (h2) in the OAP mirror (20) are used to transmit laser beams emitted from lasers 161 and 163 above and below the optical centerline of the OAP mirror (20) and form two laser dots, S1 and S2, respectively, on the target object. The target point Tp between the two laser dots S1 and S2 is the intended target region for a temperature reading. FIG. 16C schematically illustrates an IR thermometer system (160_2) according to another exemplary embodiment of the invention, which is similar to that of FIG. 16B, but where a centerline through hole (22) is used to enable real time “on-axis” viewing by eye (pin hole lens) or via a pin hole camera (164) of a target spot Tp or area between laser beam dots S1 and S2.

FIG. 16D schematically illustrates an IR thermometer system (160_3) according to another exemplary embodiment of the invention, in which primary flat first surface mirror (165) is used in conjunction with a laser (161) for IR thermometer reading. The mirror (165) is disposed at a 45° angle and a through hole (h1) is formed through the mirror (165) off center to emit a laser beam from the laser (161) behind the mirror (165) out to target a spot S1 in the scene near a target point Tp for which a temperature will be read. The mirror (165) reflects the returning IR thermal energy to the IR thermometric detector (162) which makes the temperature reading. FIG. 16E schematically illustrates an IR thermometer system (160_4) according to another exemplary embodiment of the invention, in which the primary flat first surface mirror (165) is used in conjunction with two lasers (161) and (163) for IR thermometer reading. In FIG. 16E, the lasers (161) and (163) are positioned to emit laser beams that are reflected off the front surface of the mirror (165) form laser spots S1 and S2 above and below the target point Tp to be read.

### Wide Angle Viewing Optical Systems

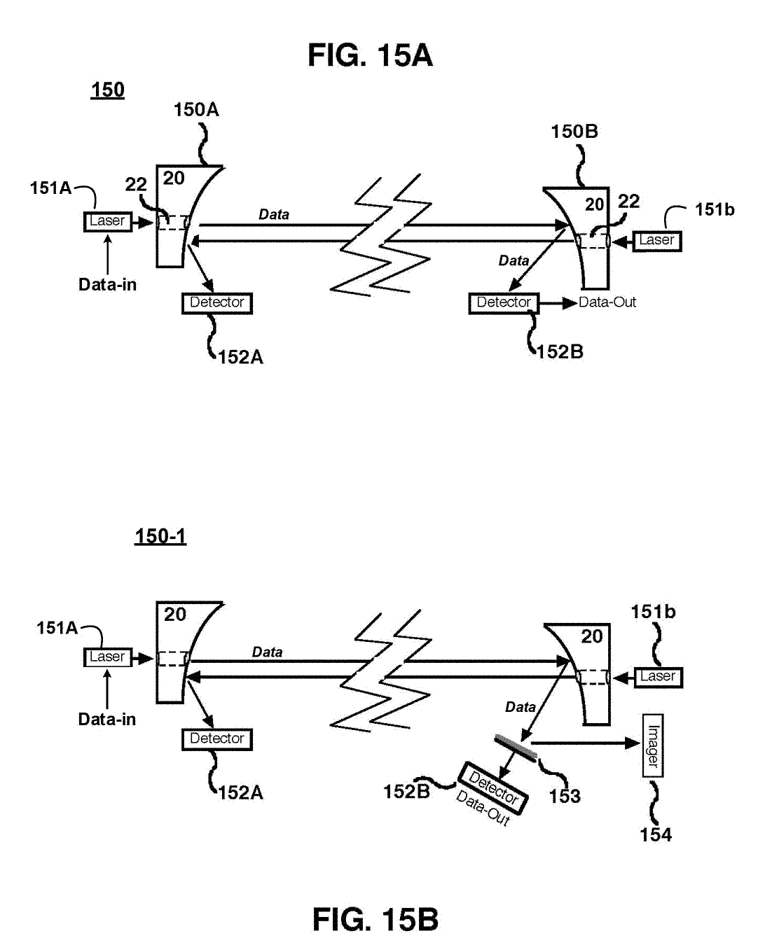

In other exemplary embodiments of the invention, wide angle viewing optical systems can be implemented using first surface OAP mirrors as secondary mirrors to reflect and focus photonic radiation from a primary mirror providing a wide-angle view of a target scene. For instance, FIG. 17 schematically illustrates a wide angle viewing optical system (170) according to an exemplary embodiment of the invention comprising a primary mirror (M1) and a secondary mirror (M2), wherein the primary mirror M1 is an external dome mirror (171) and the secondary mirror M2 is an OAP mirror (20) having a centerline through hole (22). The primary dome mirror (171) is positioned in front of the secondary OAP mirror (20) to acquire an extremely wide view of a scene. In this embodiment, incoming rays (Rs) of photonic radiation from the scene are reflected by the surface of the dome mirror (171) and the reflected rays R1 are directed to the secondary OAP mirror (20). The incident rays R1 are reflected and focused by the secondary OAP mirror (20) to form an intermediate off-axis image R2. In addition, a pin hole camera (172) can be positioned as shown to acquire an on-axis image from photonic radiation that passes through the centerline through hole (22), wherein the on-axis and off-axis images can be acquired for different spectral bands.

In effect, the secondary OAP mirror (20) can generate an image of a 360° view of the scene around the primary dome mirror (171) as the optical view is at a right angle to the center of the arch of the dome mirror (171). Although the optical system (170) adds circular distortion to the acquired on-axis and off-axis images, such distortion can be corrected using well known image processing techniques (e.g., COTS) that can be applied to the video to rearrange the pixel data into a flat two-dimensional format of the acquired image as would be perceived by an individual.

In the exemplary embodiment of FIG. 17, the primary and secondary mirrors M1 and M2 can be optically aligned by using a laser to emit a laser beam from the back of the OAP mirror (20) through the centerline hole (22) along the optical centerline of the OAP mirror (20) and form a laser dot on the surface of the primary dome mirror (171). In this manner, the position of the dome mirror (171) can be adjusted so that the laser dot is aligned to the center point on the reflective surface of the dome mirror (171) such that the optical centerline of the OAP mirror (20) is aligned with the optical axis (C) of the primary dome mirror (171 (or some other point on the mirror (M1) as may be desired for a given application).

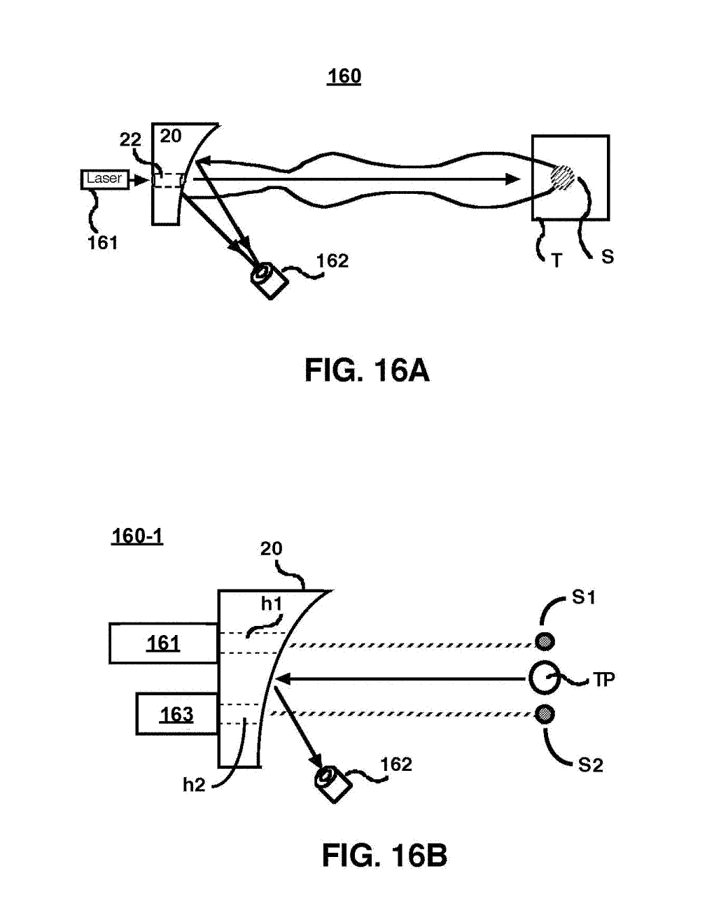

FIG. 18 schematically illustrates a wide angle viewing optical system (180) according to another exemplary embodiment of the invention comprising a primary mirror (M1) and a secondary mirror (M2), wherein the primary mirror is a fish-eye lens (181) and the second mirror is an OAP mirror (20). The fish-eye lens (181) is positioned in front of the secondary OAP mirror (20) to acquire an extremely wide view of a scene. In this embodiment, incoming rays (Rs) of photonic radiation from the scene enter the lens (181) and emerge as parallel rays R1 that are directed to the secondary OAP mirror (20). The incident rays R1 are reflected and focused by the secondary OAP mirror (20) to form an intermediate off-axis image R2. To facilitate very wide angle viewing, a combination of a conventional wide angle lens (181) as the primary element and the OAP mirror (20) as the secondary and a tertiary optical element (182) (if needed) can be used.

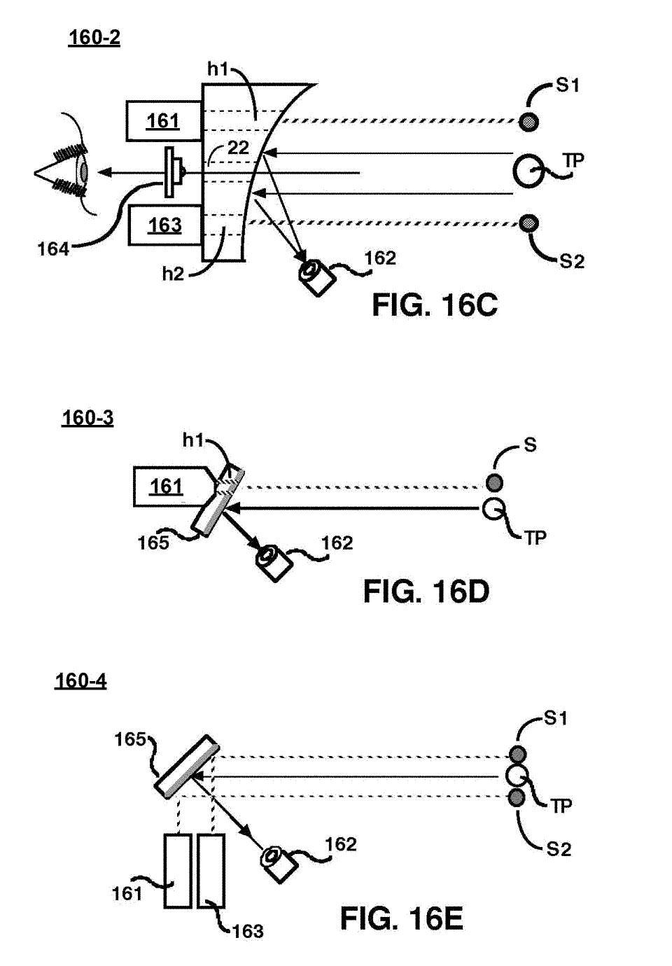

FIG. 19 schematically illustrates a wide angle viewing optical system (190) according to another exemplary embodiment of the invention illustrates to provide wide angle viewing using an external corner mirror. In particular, the optical system (190) comprises an external corner mirror (191) as the primary mirror, and an OAP mirror (20) as a secondary mirror. The primary corner mirror (191) comprises two reflective faces (191a) and (191b), wherein the reflective face (191a) reflects incident rays of photonic radiation from one (right) side of a scene and the reflective face (191b) reflects incident rays of photonic radiation from another (left) side of the scene. The external corner mirror (191) can be set at an appropriate angle to acquire the entire desired scene wherein the reflected rays from the corner mirror (191) are directed to the OAP mirror (20) and then reflected and focused as rays R2 forming an intermediate off-axis image that is captured by an imager (192). The captured image can be processed to provide a split screen image (193) comprising separate left and right views from the reflections of the corresponding reflective faces (191a) and (191b) of the corner mirror (191), but which contain the complete scene view. The flat reflective faces of the corner mirror (191) can provide a small amount of size distortion of the scene as reflections from portions of the mirror surface closer to the camera will appear larger than reflections from portions of the mirror surface further away from the camera, which distortions appear as an exaggerated perspective. The severity of the mirror angles will determine the amount of distortion. If a desired angle creates excessive distortion, known image processing software techniques can be used to correct such distortion in the video image.

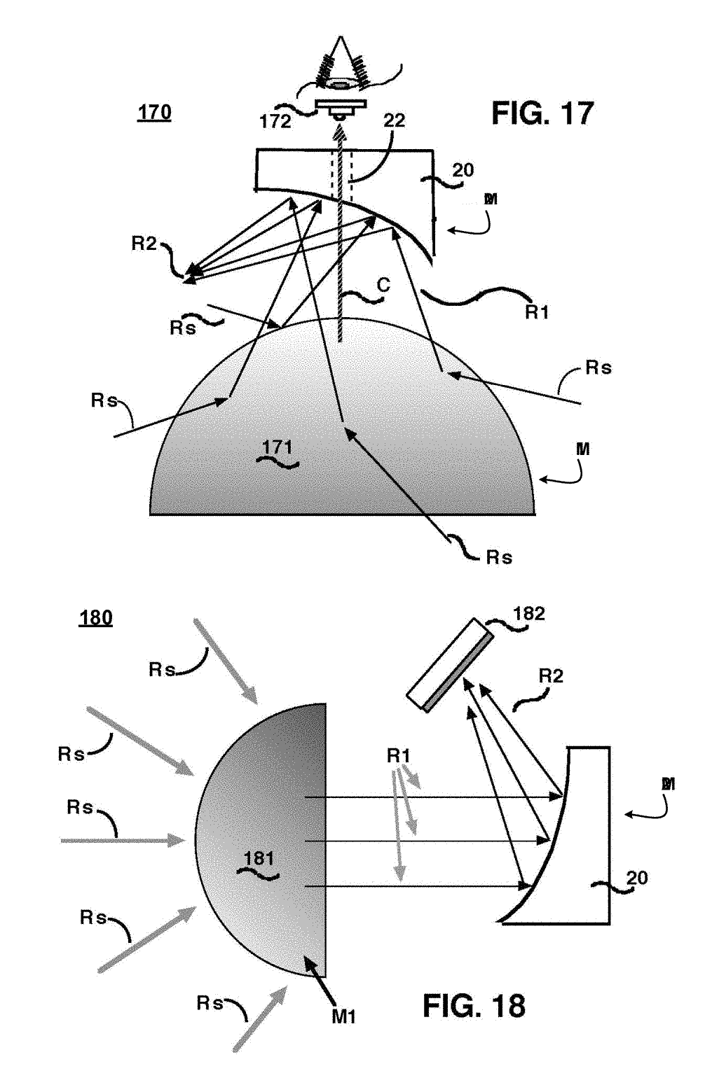

FIGS. 20A and 20B schematically illustrates a wide angle viewing optical system (200) according to another exemplary embodiment of the invention to provide wide angle viewing using an external corner mirror. FIG. 20A schematically illustrates the optical system (200) comprising an external corner mirror (201) as a primary mirror M1 and an OAP mirror (20) as a secondary mirror. The primary corner mirror (201) comprises two reflective faces (201a) and (201b), wherein the reflective face (201a) reflects incident rays of photonic radiation from one (right) side of a scene and the reflective face (201b) reflects incident rays of photonic radiation from another (left) side of the scene. The mirror surfaces (201a) and (201b) have small through holes (h1) and (h2), respectively, formed in the optical center points of the mirror surface.

As shown in FIG. 20B, laser devices (202) and (203) are disposed inside the corner mirror (201) behind respective mirror faces (201a) and (201b) to emit laser beams b1 and b2, respectively along the optical center lines of respective mirrors. In this embodiment, reflected rays R1 from each mirror surface (201a) and (201b) of the corner mirror (201) are directed to the OAP mirror (20) and then reflected and focused as rays R2 forming an intermediate off axis image that is captured by an imager (192). The captured image can be processed to provide a split screen image (193) comprising separate left and right views from the reflections of the corresponding reflective faces (201a) and (201b) of the corner mirror (201), and which contain the laser spots on viewed targets for applications such as target identification and distance measurements as discussed above.

In other exemplary embodiment, the elements (202) and (203) within the corner mirror (201) may be pin hole cameras (instead of lasers) to allow simultaneous real time viewing of the different scenes viewable by each mirror face. In this optical framework, by forming the holes (h1) and (h2) at center points of the mirror surfaces (201a) and (201b) (aligned to the optical axis), each pin hole camera (202) and (203) can acquire an on-axis view of the left and right sides of a scene from photonic radiation that passes through the centerline through hole (h1) and (h2), while simultaneously obtaining on off axis view of the left and right sides of the scene over the same optical center lines of mirror surfaces (201a) and (210b) The on-axis and off-axis images can be acquired for different spectral bands as desired for a given application.

The primary and secondary mirrors M1 and M2 in FIG. 20A can be optically aligned by using a laser (204) to emit a laser beam from the back of the OAP mirror (20) through the centerline hole (22) along the optical centerline of the OAP mirror (20) and form a laser dot on the mirror (201). In this manner, the position of the corner mirror (201) can be adjusted so that the laser dot is aligned to a center point of a ridge line formed at the meeting edges of the mirror surfaces (201a) and (201b) (or some other point on the mirror 201 as may be desired for a given application).

### Wide Spectrum Microscope Optics

FIG. 21 schematically illustrates an optical system according to another exemplary embodiment of the invention to provide wide spectrum optics for a microscope. In particular. FIG. 21 schematically illustrates a microscope (210) comprising primary M1 and secondary M2 optics implemented using wide spectrum first surface mirrors disposed in a device housing (211). The primary optic M1 is implemented using an OAP mirror and the secondary optic M2 is implemented using a plurality of first surface parabolic mirrors for variable magnification. A plurality of light sources (212, 213, 214) are used to illuminate a specimen disposed on a specimen stage (215) for observation. The light source (212) is disposed below the stage (215) for backside illumination. The light sources (213) and (214) are disposed at the back side of the primary OAP optic (M1) and aligned to respective through holes (h1) and (h2) formed in the mirror substrate in the region outside the clear aperture area (CAA) of the primary optic. The light sources (213) and (214) emit light which passes through the holes (h1) and (h2) to provide top side illumination of the specimen disposed on the stage (215) for observation.

In operation, photonic radiation from a target specimen under observation passes through an input aperture (216) to the primary optic (M1). The primary OAP optic M1 reflects and focuses incident photonic radiation “off-axis” towards the secondary optic (M2). The secondary optic M2 magnifies and reflects the “off-axis” image along a path to an output aperture (217) for direct viewing or to an imager (218) for generating an image. The secondary optic M2 may be implemented using a slider or wheel mechanisms comprising a plurality parabolic mirrors that are selectable for different magnifications, such as described above with reference to FIGS. 6C and 61).

The exemplary microscope optical system with the primary OAP mirror (M1) allows for a wide spectrum microscope. The light sources (213) and 214) can be employed to direct illumination in a desired spectrum at the object under observation. The illumination can be aimed very near the lower optical element such as a conventional microscope or it can be aimed a distance away from a lower optical element to facilitate a microscope set up for objectives and illumination referred to as ELWD (extremely long working distance) or SLWD (super long working distance) or LWD (long working distance). An extended distance, d, between the object and the lower optical element allows the physical space for the user to put probes, pointers, or other needed apparatus between the object and lower optics. In a conventional microscope, this would require special optics that are very expensive as well as special illumination from the top, which would also add significant expense to the device. The off-axis first surface mirror design allows imaging in any desired portion of the wideband spectrum of the mirror optics. A conventional microscopes optics only allows imaging in a narrow band of the optics characteristics like UV, visible or IR alone, which optics are extremely expensive. In contrast, the off-axis first surface mirror design allows all of these bands to be imaged with the same optics.

### Wide Spectrum Optics Using Planar Mirror as Primary Optic

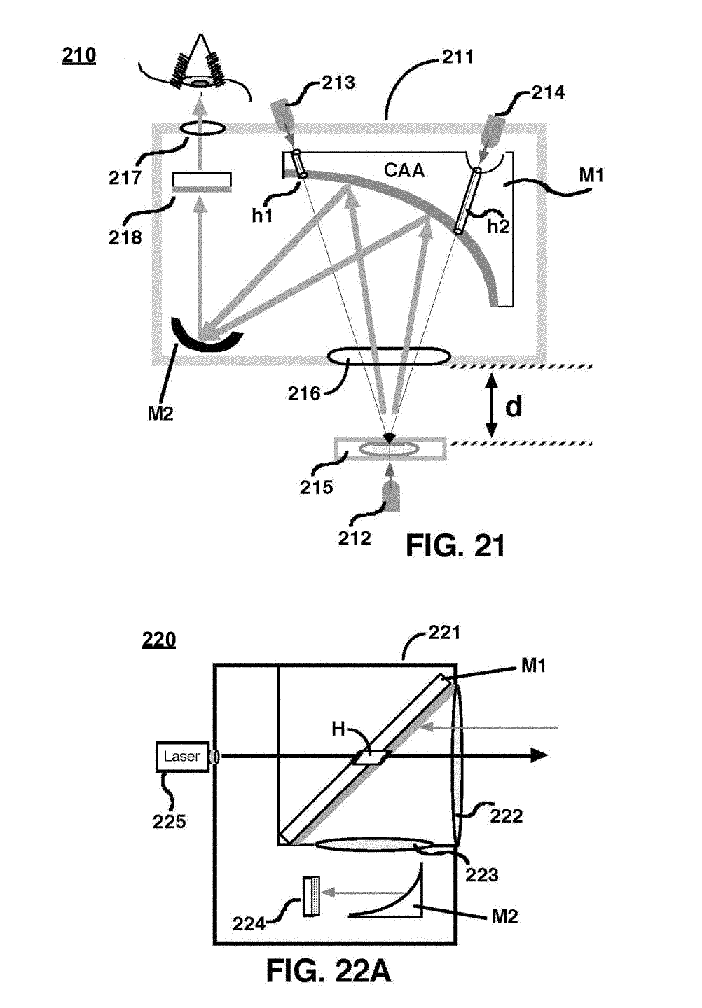

In other exemplary embodiments of the invention, optical systems can be implemented in which planar first surface mirrors are used as primary optics for wide spectrum applications. For example, FIG. 22A schematically illustrates an optical system (220) according to an exemplary embodiment of the invention comprising a primary first surface planar mirror M1 and a secondary first surface OAP mirror M2 disposed in a housing (221). Incoming photonic radiation from a target scene which passes through protective window (222) is reflected by the primary mirror M1 through a field stop opening (223) to the secondary OAP mirror M2. The secondary OAP mirror reflects and focuses incident photonic radiation from the primary mirror M1 to an imager (224). The primary mirror M1 includes a through hole H that is aligned to an input optical centerline of the system (220). A laser device (225) mounted to the housing (221) emits a laser beam that passes through the hole H of the primary mirror M1 and travels along the input optical centerline towards a target object, allowing laser targeting functions similar to those discussed above.

FIG. 22B schematically illustrates an optical system (220_1) according to another exemplary embodiment of the invention, in which wide spectrum optics include a primary first surface planar mirror M1 and a secondary first surface planar mirror M2 disposed in a housing (221). The exemplary system (220_1) is similar to the optical system (220) of FIG. 22A, except that the secondary planar mirror M2 reflects photonic radiation received from the primary mirror, along an optical path to a pin=hole camera (226) (or pin hole lens) for direct viewing. FIG. 22B illustrates an exemplary embodiment of a periscope with the optics packaged in an elongated case, providing a flat mirror periscope device that facilitates laser targeting as well as camera or direct eye viewing.

FIG. 22C schematically illustrates an optical system (220_2) according to another exemplary embodiment of the invention, which is similar to the optical system of FIG. 22B, but further includes a tertiary OAP mirror M3 with a centerline through hole. The tertiary OAP mirror M3 reflects and focuses incident photonic radiation from the secondary mirror to form an off-axis image that is captured by imager (224). The centerline through hole of the tertiary mirror M3 allows real time “on-axis” viewing of the image from M2 directly by eye or by a pinhole camera (226) disposed in back of the tertiary OAP mirror M3.

### Optical Systems for Readout for Infrared (IR) Imaging Device

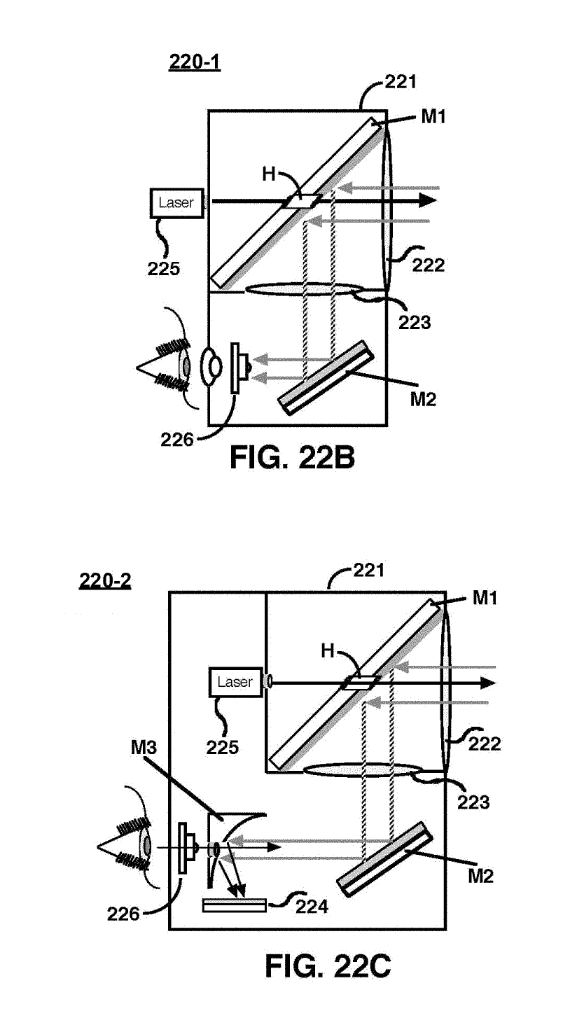

In other exemplary embodiments of the invention, optical systems can be designed using first surface mirrors to realize low cost, wide spectrum readout systems for imaging devices such as thermal imagers. FIG. 23 schematically illustrates an optical system according to an exemplary embodiment of the invention for viewing a readout image of a thermal imager device. In particular, FIG. 23 shows an IR imager device (231) having a framework based on exemplary embodiments of IR imager devices as disclosed in commonly assigned U.S. Pat. No. 7,381,935, which is incorporated herein by reference. The IR imager device (231) comprises a substrate (232) having detectors (233) on one side of the substrate (232) to detect incident IR radiation, and readout circuitry (234) on the opposite side of the substrate (232). The readout circuitry (234) and detectors (232) are electrically coupled with conductive vias (235) formed through the substrate (232). In the exemplary embodiment of FIG. 23, the readout circuit is an LCD circuit comprising an array of LCD pixels coupled to corresponding detectors in a detector array. When IR photons strike the detectors (233), each detector measures the amount of incident photons and generates a correspond variable control signal in response to the amount of incident photons striking the detector. The control signal output from a detector is used to drive a corresponding LCD pixel in proportion to the amount of IR exposure on the detectors. The resulting image can be readout from the LCD as follows.

When a reflective readout medium, such as LCD (234) is used, the readout can be achieved using an OAP mirror (20) with centerline trough hole (22), an LED (236) and lens (237) disposed “on-axis” in back of the OAP mirror (20) aligned to the centerline through hole (22) and an imager (238) disposed “off-axis”. To view the readout image from the LCD (234), the LCD (24) is illuminated by light emitted from the LED (236) which passes through the centerline hole (22) and aimed towards the LCD readout (234). The reflected photonic radiation (comprising the readout image) is focused by the OAP mirror (20) “off-axis” to the focal point of a visible light imager (238) that generates a video signal to be viewed. This configuration eliminates the need for complex ROIC of the imager and allows the use of a very low cost visible light imager to generate a video image.

In another embodiment, the imager (238) can be replaced with a planar mirror that receives and reflects the off-axis image to a view lens to allow real time viewing by eye. This lends itself to use as a hand-held battery powered field instrument. The illuminated image readout from the IR readout can be viewed by eye in real time from the flat mirror as the image is focused by the off-axis mirror and then reflected at the flat mirror.

### Cassegrian-Based Optical Systems

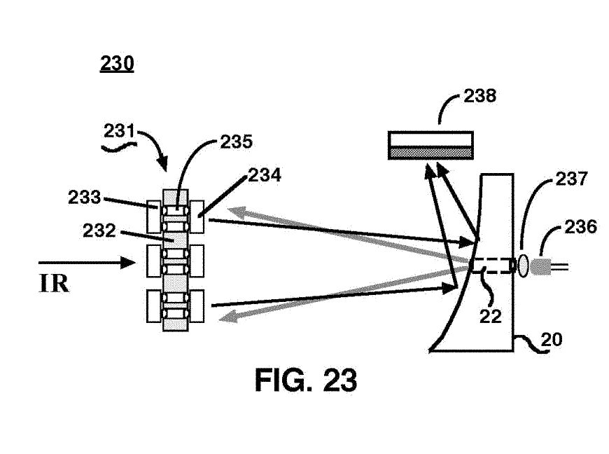

In other exemplary embodiments of the invention, cassegrian-based optical systems may be designed using various frameworks similar to those discussed above with regard to off-axis configurations. For example, FIG. 24 schematically illustrates an exemplary embodiment of an interchangeable optical lens assembly (240) having a self-contained wide spectrum cassegrian-based optical system. The lens assembly (240) comprises a housing (241) comprising a primary mirror (M1), a secondary mirror (M2) disposed in a central region of an input aperture (A1) of the housing (241), third and forth planar first surface mirrors (M3) and (M3), and an output aperture (A2). The primary mirror (M1) is a first surface concave, spherical, aspherical or parabolic mirror having a relatively large hole (H) at its center. The secondary first surface mirror (M2) is a smaller secondary convex mirror that is placed in front of the primary mirror (M1) and aligned to the center hole (H). The secondary mirror (H) is held in place by spider supports (242) for example. The primary mirror (M1) reflects and focuses incident radiation from the scene passing through the aperture (A1) towards the secondary mirror (M2). The secondary mirror (M2) reflects the light from the primary mirror (M1) back to the primary mirror (M1) through the center hole (H) towards the tertiary first surface planar mirror (M3). The secondary mirror (M2 reflects and focuses light to a focus point (FP) in front of the primary mirror (M1). The tertiary mirror (M3) reflects the light to the fourth first surface planar mirror (M4) which then reflects the light along an optical path toward the output aperture (A2).

The optical lens assembly (240) is an interchangeable lens assembly that can be connected to an imaging device (245) (e.g., IR camera body) via mating lens mounting mechanisms (243) and (244) (such as conventional industry standard lens mounting mechanisms e.g., bayonet, C-mount, CS-mount, etc.). The mounting mechanism (243) at the output aperture A2 of the device housing (241) couples to the corresponding lens mounting mechanism (244) at the input of the imaging device (245) such that optical output centerline of the lens (240) is aligned to the optical input centerline of the imaging device (245).

The exemplary lens assembly (240) of FIG. 24 is particularly useful for long distance viewing applications, wherein the increased size of the central area of the secondary mirror (M2) does not become visible in the field of view. In another exemplary embodiment as further shown in FIG. 24, a mini board camera (246) can be attached to the back surface of the secondary mirror (M2) facing the incident scene. Wiring (247) for the camera (246) can be fixed in place along the length of one of the spider supports (242). In this embodiment, the lens of the mini camera (246) is aligned to the centerline optical axis of the input optics thereby allowing the imaging device (245) and mini camera (246) to view the same wide spectrum scene simultaneously in real time over the same optical centerline, at the same or different spectral bands.

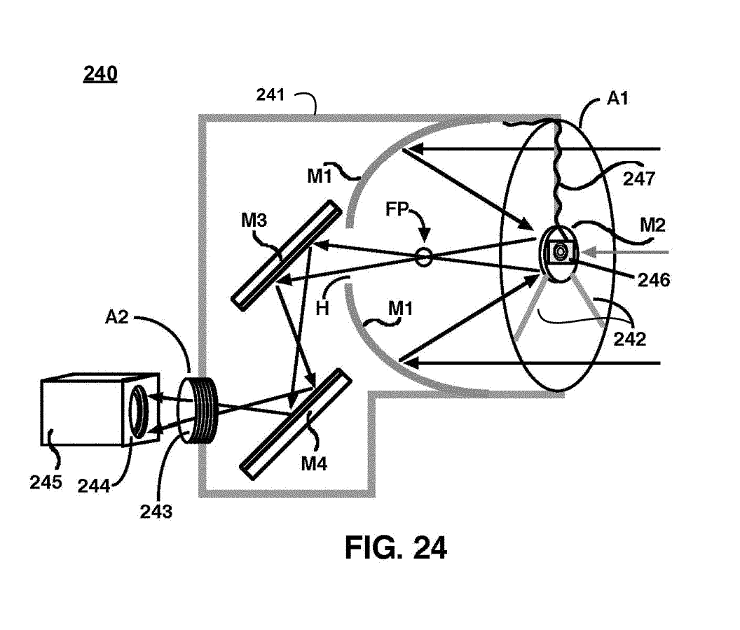

FIG. 25 schematically illustrates another exemplary embodiment of an interchangeable optical lens assembly (250) having a self-contained wide spectrum cassegrian-based optical system. The lens assembly (250) comprises a housing (251) comprising a primary mirror (M1), a secondary mirror (M2) disposed in a central region of an input aperture (A1) of the housing (241), and an output aperture (A2). The primary mirror (M1) is a first surface concave, spherical, aspherical or parabolic mirror having a relatively large hole (H) at its center. The secondary first surface mirror (M2) is a smaller secondary convex mirror that is placed in front of the primary mirror (M1) and aligned to the center hole (H). The secondary mirror (H) is held in place by spider supports (252) for example. The primary mirror (M1) reflects and focuses incident radiation from the scene passing through the aperture (A1) towards the secondary mirror (M2). The secondary mirror (M2) reflects the light from the primary mirror (M1) back to the primary mirror (M1) through the center hole (H) towards the output aperture (A2)

As in FIG. 24, the interchangeable lens assembly (250) of FIG. 25 can be connected to an imaging device (245) (e.g., JR camera body) via corresponding mating lens mounting mechanisms (253) and (244) at the output and input apertures of the lens (250) and imaging device (245), respectively. This exemplary embodiment provides an on-axis configuration wherein the output and input optical centerlines of the optics are aligned. In addition, similar to the lens assembly of FIG. 24, a mini board camera (246) can be attached to the back surface of the secondary mirror (M2) facing the incident scene. Since the lens of the mini camera (246) is aligned to the centerline optical axis of the input optics, the imaging device (245) and mini camera (246) can view the same wide spectrum scene simultaneously in real time over the same optical centerline, in the same or different spectral bands

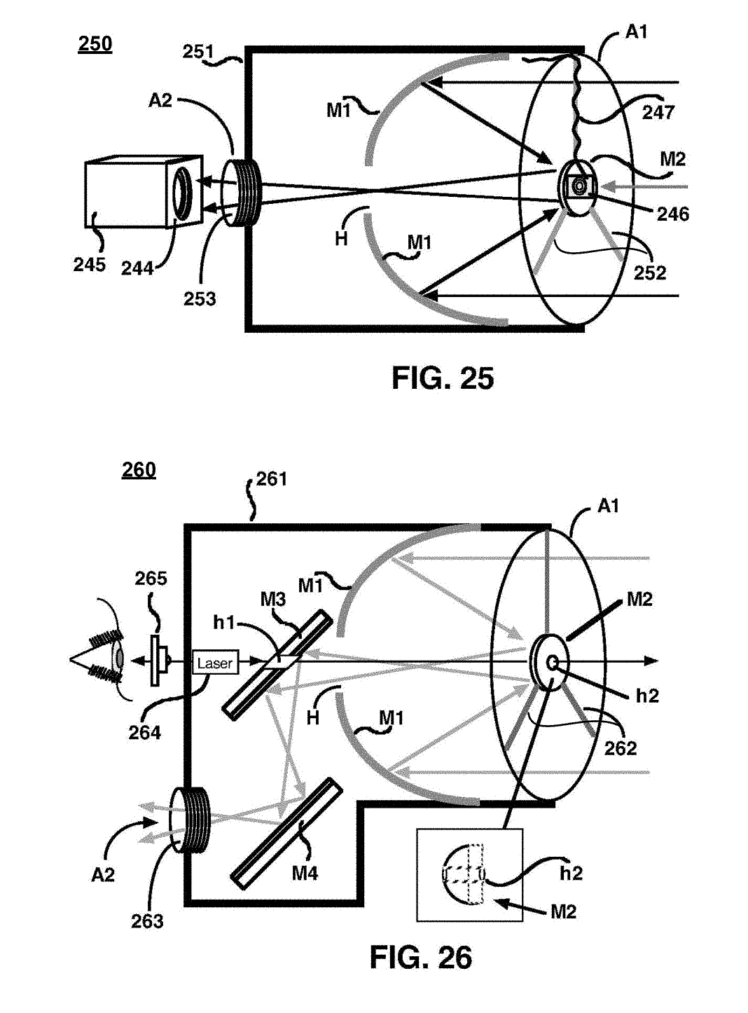

FIG. 26 schematically illustrates another exemplary embodiment of an interchangeable optical lens assembly (260) having a self-contained wide spectrum cassegrian-based optical system. Similar to the exemplary embodiment of FIG. 24, the lens assembly (260) shown in FIG. 26 comprises a housing (261) comprising a primary mirror (M1), a secondary mirror (M2) disposed in a central region of an input aperture (A1) of the housing (261) and held in position via spider supports (262), third and fourth planar first surface mirrors (M3) and (M3), and an output aperture (A2) with a lens mount (263). In FIG. 26, however, small diameter holes (h1) and (h2) are formed in the tertiary mirror (M3) and secondary mirror (M2), respectively, such that the holes (h1) and (h2) are optically aligned to the optical centerline axis of the mirrors. The holes (h1) and (h2) can be used in conjunction with a laser (264) to emit a laser beam out towards a target scenes along the on-axis optical input centerline, or otherwise allow direct viewing with a pin hole lens or pin hole camera (265) using techniques discussed above. In other exemplary embodiments, a boroscopic device can be inserted through the hole (h1) of the tertiary mirror (M3) and extend to the through hole (h2) of the secondary mirror (M2), wherein a laser beam can be transmitted through the boroscope or the boroscope can be used for real-time direct viewing along the input optical centerlines of the optics, as discussed above.

Although exemplary embodiments of the invention have been described herein with reference to the accompanying drawings, it is to be understood that the scope of the invention is not limited to those precise embodiments, and that various other changes and modifications may be affected therein by one skilled in the art without departing from the scope or spirit of the invention.

We claim:

1. An optical lens device, comprising:
a device housing comprising an input aperture and an output aperture, the input aperture comprising an optical centerline;
an optical system disposed within the device housing, wherein the optical system comprises:
a primary mirror comprising a concave reflective surface that is configured to reflect photonic radiation, and a through-hole formed through a central region of the primary mirror; and
a secondary mirror comprising a convex reflective surface configured to reflect photonic radiation;
wherein the primary and secondary mirrors are fixedly positioned within the device housing such that (i) the concave reflective surface of the primary mirror faces the input aperture with the through-hole aligned to the optical centerline of the input aperture, and (ii) the secondary mirror is disposed in a central region of the input aperture with the convex reflective surface of the secondary mirror facing towards the primary mirror and aligned to the through-hole of the primary mirror and to the optical centerline of the input aperture;
wherein the primary mirror is configured to reflect and focus photonic radiation, which passes through the input aperture, towards the secondary mirror;
wherein the secondary mirror is configured to reflect and focus photonic radiation, which is received from the primary mirror, to a focal point that is aligned to the optical centerline extending through the through-hole of the primary mirror, wherein the focused photonic radiation reflected from the secondary mirror passes through the through-hole of the primary mirror and along an optical path towards the output aperture; and
a camera device coupled to a back surface of the secondary mirror, wherein a lens of the camera device is aligned to the optical centerline of the input aperture.

2. The optical lens device of claim 1, further comprising spider supports to hold the secondary mirror in place in the central region of the input aperture.

3. The optical lens device of claim 2, further comprising camera wiring connected to at least one of the spider supports.

4. The optical lens device of claim 1, wherein the output aperture of the device housing is disposed in back of the primary mirror and aligned with the through-hole of the primary mirror.

5. The optical lens device of claim 1, wherein the output aperture comprises a coupling mechanism to removably attach an imaging device to the device housing of the optical lens device.

6. The optical lens device of claim 6, further comprising the imaging device attached to the device housing, wherein an imager of the imaging device is aligned with an optical centerline of the output aperture.

7. The optical lens device of claim 6, wherein the camera device comprises an imager configured to detect photonic radiation in a first portion of the electromagnetic spectrum, and wherein the imager of the imaging device is configured to detect photonic radiation in a second portion of the electromagnetic spectrum.

8. The imaging device of claim 7, wherein the first portion of the electromagnetic spectrum comprises a visible light spectrum, and wherein the second portion of the electromagnetic spectrum comprises a thermal infrared spectrum.

9. The optical lens device of claim 1, wherein the concave reflective surface of the primary mirror is spherical-shaped.

10. The optical lens device of claim 1, wherein the concave reflective surface of the primary mirror is parabolic-shaped.

11. The optical lens device of claim 1, wherein the optical system further comprises a third mirror disposed behind the primary mirror, wherein the third mirror comprise a reflective surface that is configured to reflect photonic radiation that passes through the through-hole of the primary mirror along the optical path towards the output aperture.

12. An optical lens device, comprising:
a device housing comprising an input aperture and an output aperture, the input aperture comprising an optical centerline; and
an optical system disposed within the device housing, wherein the optical system comprises:
a primary mirror comprising a concave reflective surface that is configured to reflect photonic radiation, and a through-hole formed through a central region of the primary mirror;
a secondary mirror comprising a convex reflective surface configured to reflect photonic radiation, and a through-hole formed through a central region of the primary mirror; and
a third mirror comprising a reflective surface configured to reflect photonic radiation, and a through-hole formed through a central region of the third mirror;
wherein the primary, secondary, and third mirrors are fixedly positioned within the device housing such that (i) the concave reflective surface of the primary mirror faces the input aperture with the through-hole aligned to the optical centerline of the input aperture, (ii) the secondary mirror is disposed in a central region of the input aperture with the convex reflective surface of the secondary mirror facing towards the primary mirror and aligned to the through-hole of the primary mirror and to the optical centerline of the input aperture, and (iii) the third mirror is disposed behind the primary mirror with the through-hole of the third mirror aligned to the through-hole of the secondary mirror and to the optical centerline of the input aperture;
wherein the primary mirror is configured to reflect and focus photonic radiation, which passes through the input aperture, towards the secondary mirror;
wherein the secondary mirror is configured to reflect and focus photonic radiation, which is received from the primary mirror, to a focal point that is aligned to the optical centerline extending through the through-hole of the primary mirror, wherein the focused photonic radiation reflected from the secondary mirror passes through the through-hole of the primary mirror; and
wherein the third mirror is configured to reflect a portion of the photonic radiation which passes through the through-hole of the primary mirror along an optical path towards the output aperture, and to pass a portion of the photonic radiation through the through-hole of the third mirror.

13. The optical lens device of claim 12, further comprising a camera device disposed behind the third mirror, wherein a lens of the camera device is aligned to the through-hole of the third mirror and to the optical centerline of the input aperture.

14. The optical lens device of claim 13, wherein the camera device comprises an imager configured to detect photonic radiation in a visible light portion of the electromagnetic spectrum.

15. The optical lens device of claim 12, wherein the output aperture comprises a coupling mechanism to removably attach the device housing of the optical lens device to an imaging device.

16. The optical lens device of claim 15, wherein the imaging device comprises an imager configured to detect photonic radiation in a thermal infrared portion of the electromagnetic spectrum.

17. The optical lens device of claim 12, wherein the concave reflective surface of the primary mirror is spherical-shaped.

18. The optical lens device of claim 12, wherein the concave reflective surface of the primary mirror is parabolic-shaped.

19. The optical lends device of claim 12, wherein the third mirror comprises a planar reflective surface.

20. The optical lens device of claim 12, further comprising a light source disposed behind the third mirror and configured to emit a laser beam of light that passes through the through-holes of the primary, secondary, and third mirrors towards a target scene.
